(19) United States
(12) Patent Application Publication
(10) Pub. No.: US 2013/0336632 A1
(43) Pub. Date: Dec. 19, 2013

(54) RECORDING DEVICE/METHOD/MEDIUM AND REPLAYING DEVICE/METHOD

(71) Applicant: Akinobu Watanabe, Kawasaki (JP)

(72) Inventor: Akinobu Watanabe, Kawasaki (JP)

(21) Appl. No.: 13/884,426

(22) PCT Filed: Mar. 11, 2011
(86) PCT No.: PCT/JP2011/001426

§ 371 Date: Aug. 20, 2013

(51) Int. Cl. H04N 9/87

(52) U.S. Cl. CPC H04N 9/87
USPC 386/241

(57) ABSTRACT

The present invention is to provide a play list in which information with which 3D contents can be displayed in a display correctly is recorded, a recording/reproducing device/method/medium and a reproducing device/method of the play list. For example, the present invention is to provide the recording/reproducing device/method/medium and the reproducing device/method in which a 3D system is recorded/reproduced in the play list.

The recording method of recording information in the recording medium, includes
a step of recording AV streams and
a step of recording the play list in which reproduce order of the AV streams is prescribed and
the play list includes user interface application information,
the interface application information including 3D type information representing the 3D system of 3D contents in the play list.

### TECHNICAL FIELD

The present invention relates to a recording device/method/medium and a reproducing device/method.

### BACKGROUND ART

As a background art of the present invention, there is JP-A-2007-280496 (Patent Literature 1). This publication describes as follows:

“(Problem) In a real play list, a flag indicating whether reproduce is possible or not is set to inhabitation of reproduction, whereas a virtual play list referring to the same clip shows that reproduce is possible.

(Solution Measures) There are provided all-play-list information management means for managing information in all play lists (containing real and virtual play lists) in a folder, play list attribute change means for changing an attribute of a designated play list, target clip attribute change means for changing an attribute of all clips being referred to by the play list, all-clip information management means for managing information of all clips in the folder, play list attribute change judgment means for judging whether the attribute of the play list being referred to the clip subjected to change is changed or not and disk writing means for writing information of an updated play list in a disk.”

### CITATION LIST

### Patent Literature

Patent Literature 1: JP-A-2007-280496

### SUMMARY OF INVENTION

### Technical Problem

The patent literature 1 describes the structure of a play list of AV data and an AV data editing device and method. However, the play list of the patent literature 1 does not consider the problem that a 3D system cannot be distinguished or judged from the play list when contents are 3D.

Such a play list structure sometimes cannot display the 3D contents in a display correctly, for example.

Accordingly, the present invention is to provide a play list in which information with which 3D contents can be displayed in a display correctly is recorded and a reproducing/reproduce device/method/medium and a reproducing device/method of the play list. For example, the present invention is to provide a recording/reproducing device/method/medium and a reproducing device/method in which a 3D system can be recorded/reproduced in the play list.

### Solution to Problem

In order to solve the above problem, the structure described in the Claims is adopted, for example.

The present invention includes plural measures for solving the above problem and an example thereof is described as follows:

A recording method of recording information in a recording medium, comprises

a step of recording AV streams, and

a step of recording a play list in which reproduce order of the AV streams is prescribed, and

wherein

the play list includes user interface application information and

the interface application information includes 3D type information representing a 3D system of 3D contents in the play list.

### Advantageous Effects of Invention

According to the present invention, there can be provided a recording/reproducing device/method/medium and a reproducing device/method in which 3D contents can be displayed in a display correctly.

Other problems, structures and effects except the above will be apparent from the following description of embodiments.

### BRIEF DESCRIPTION OF DRAWINGS

FIG. 1 is a schematic diagram illustrating an example of a directory structure and a file structure;

FIG. 2 is a schematic diagram illustrating an example of the structure of a play list file;

FIG. 3 is a schematic diagram illustrating an example of the structure of user interface application information;

FIG. 4 is a schematic diagram illustrating an example of the structure of a time zone;

FIG. 5 is a schematic diagram illustrating an example of the structure of play list information;

FIG. 6 is a schematic diagram illustrating an example of the structure of a play item;

FIG. 7 is a schematic diagram illustrating an example of the structure of bridge sequence information;

FIG. 8 is a schematic diagram illustrating an example of the structure of a sub play item;

FIG. 9 is a schematic diagram illustrating an example of the structure of MPEG-2 transport stream;

FIG. 10 is a schematic diagram illustrating an example of a recording device showing a system of an embodiment;

FIG. 11 is a schematic diagram illustrating an example of a reproducing device showing a system of an embodiment;

FIG. 12 is a schematic diagram illustrating an example of real play lists;

FIG. 13 is a schematic diagram illustrating an example of generation of the real play list;

FIG. 14 is a schematic diagram illustrating an example of division of a real play list;

FIG. 15 is a schematic diagram illustrating an example of division of real play lists;

FIG. 16 is a schematic diagram illustrating an example of connection of real play lists;

FIG. 17 is a schematic diagram illustrating an example of connection of a real play list;

FIG. 18 is a schematic diagram illustrating an example of deletion of a real play list;

FIG. 19 is a schematic diagram illustrating an example of partial deletion of the head part of a real play list;

FIG. 20 is a schematic diagram illustrating an example of partial deletion of the head part of a real part list;

FIG. 21 is a schematic diagram illustrating an example of partial deletion of an intermediate part of a real play list;

FIG. 22 is a schematic diagram illustrating an example of partial deletion of an intermediate part of a real play list;

FIG. 23 is a schematic diagram illustrating an example of assemble editing (non-seamless connection between two play items);

FIG. 24 is a schematic diagram illustrating an example of assemble editing (non-seamless connection between two play items);

FIG. 25 is a schematic diagram illustrating an example of assemble editing (seamless connection between two play items);

FIG. 26 is a schematic diagram illustrating an example of assemble editing (seamless connection between two play items);

FIG. 27 is a schematic diagram illustrating an example of a recording device showing a system of an embodiment;

FIG. 28 is a schematic diagram illustrating an example of a recording/reproducing part of the recording device showing a system of the embodiment;

FIG. 29 is a schematic diagram illustrating an example of an image decoding conversion part of the recording device showing a system of the embodiment;

FIG. 30 shows an example of processing of a recording/reproducing device and a display showing a system of the embodiment;

FIG. 31 shows an example of processing of the recording/reproducing device and the display showing a system of the embodiment;

FIG. 32 is a schematic diagram illustrating an example of a list of contents displayed in the display; and

FIG. 33 shows an example of processing of the recording/reproducing device and the display showing a system of the embodiment.

### DESCRIPTION OF EMBODIMENTS

Embodiments in which the present invention is applied to a recording device/method/medium and a reproducing device/method are now described.

### Embodiment 1

### (Recording Medium)

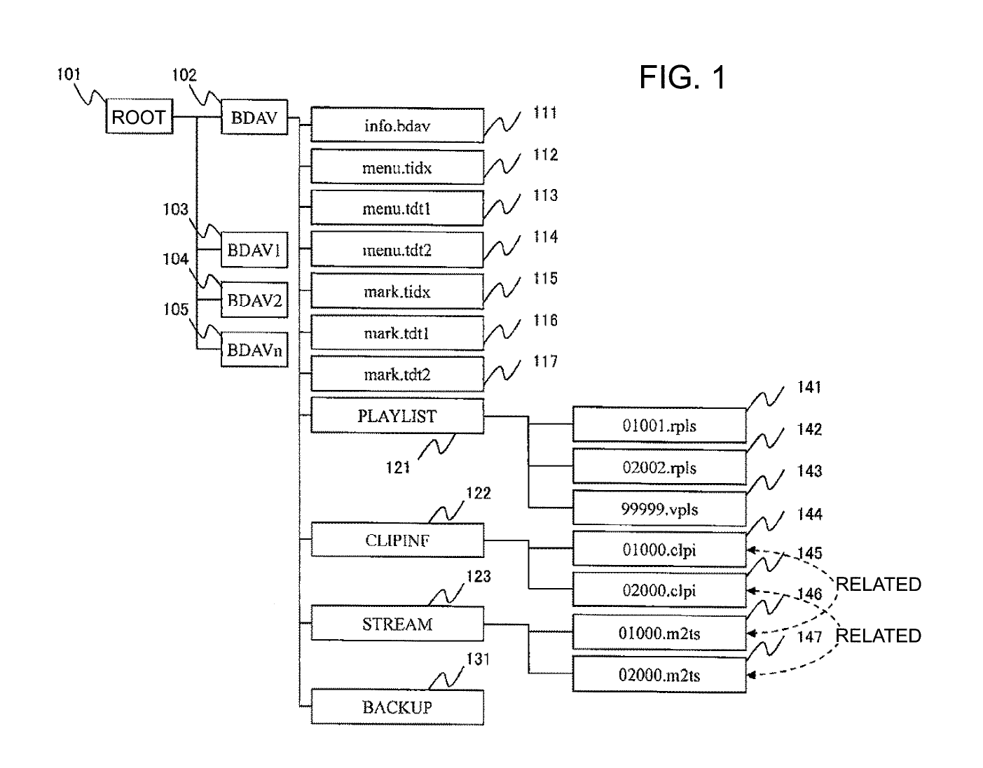

FIG. 1 is a schematic diagram illustrating an example of a directory structure and a file structure showing a system of an embodiment of the present invention.

Reference numeral 101 denotes a root directory including at least a BDAV directory.

Reference numeral 102 denotes a BDAV directory including a PLAYLIST directory 121, a CLIPINF directory 122, a STREAM directory 123 and a BACKUP directory 131.

The root directory 101 includes external BDAV directories such as a BDAV1 directory 103, a BDAV2 directory 104 and a BDAVn directory 105. Here, n of the BDAVn directory is a natural number corresponding to the number of external BDAV directories and continued from 1. For example, when four external BDAV directories exist under the root directory 101, n is 4 and the respective directory names are BDAV1, BDAV2, BDAV3 and BDAV4.

The PLAYLIST directory 121 includes management files such as real play list files 141 and 142 and a virtual play list 143.

The CLIPINF directory 122 includes management files such as clip information files 144 and 145.

The STREAM directory 123 includes stream files such as stream files 146 and 147.

An info.bdav file 111, which is a file recording therein general information, is stored in each BDAV directory.

A menu.tidx file 112 records therein header information of a menu thumbnail.

A menu.tdt1 file 113 records therein picture data of the menu thumbnail. A menu.tdt2 file 114 is also a file similar to the menu.tdt1 file 113.

A mark.tidx file 115 records therein header information of a mark thumbnail.

A mark.tdt1 file 116 records therein picture data of the mark thumbnail. A mark.tdt2 file 117 is also a file similar to the mark.tdt1 file 116.

A 01001.rpls file 141 contains information relative to a real play list. One rpls file is produced for one real play list. A 02002.rpls file 141 is also a file similar to the file 141.

A 99999.vpls file 143 contains information relative to a virtual play list. One vpls file is produced for one virtual play list.

A 01000.clpi file 144 is a clip information file which contains clip information related to AV stream file (clip AV stream file and bridge clip AV stream file). A 02000.clpi file 145 is also a file similar to the file 144.

A 01000.m2ts file 146 is an AV stream file which contains MPEG-2 transport stream. A 02000.m2ts file 147 is also a file similar to the file 146.

A file name “zzzzz” of the clip information file zzzzz.clpi and the AV stream file zzzzz.m2ts is a 5-digit integer and the same 5-digit integer is assigned to the clip information file and the AV stream file related to each other.

Further, the clip information file zzzzz.clpi and the AV stream file zzzzz.m2ts are set as a group to be named a clip.

As described above, the play list is files stored in the PLAYLIST directory.

The real play list file and the virtual play list file are now described in detail.

Both of the real play list and the virtual play list include data described below.

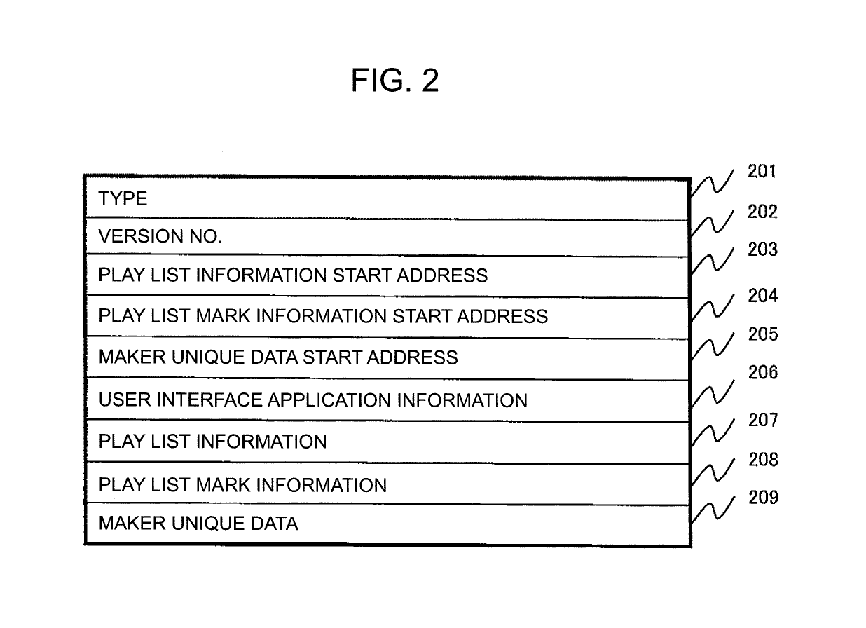

FIG. 2 shows an example of the structure of the play list file.

Reference numeral 201 denotes a type identifier in which information indicating a play list file is stored. For example, when a value of “PLAYLIST” is set in an ASCII code, the file can be identified as a play list file.

Reference numeral 202 denotes a version number representing the version of the play list file.

Reference number 203 denotes a play list information start address which is a value indicating a relative start position of play list information in the play list file in byte unit. The head thereof starts from 0.

Reference numeral 204 denotes a play list mark information start address which is a value indicating a relative start position of play list mark information in the play list file in byte unit. The head thereof starts from 0.

Reference numeral 205 denotes a maker unique data start address which is a value indicating a relative start position of maker unique data information in the play list file in byte unit. The head thereof starts from 0. When 0 is set as this value, the maker unique data information is not present.

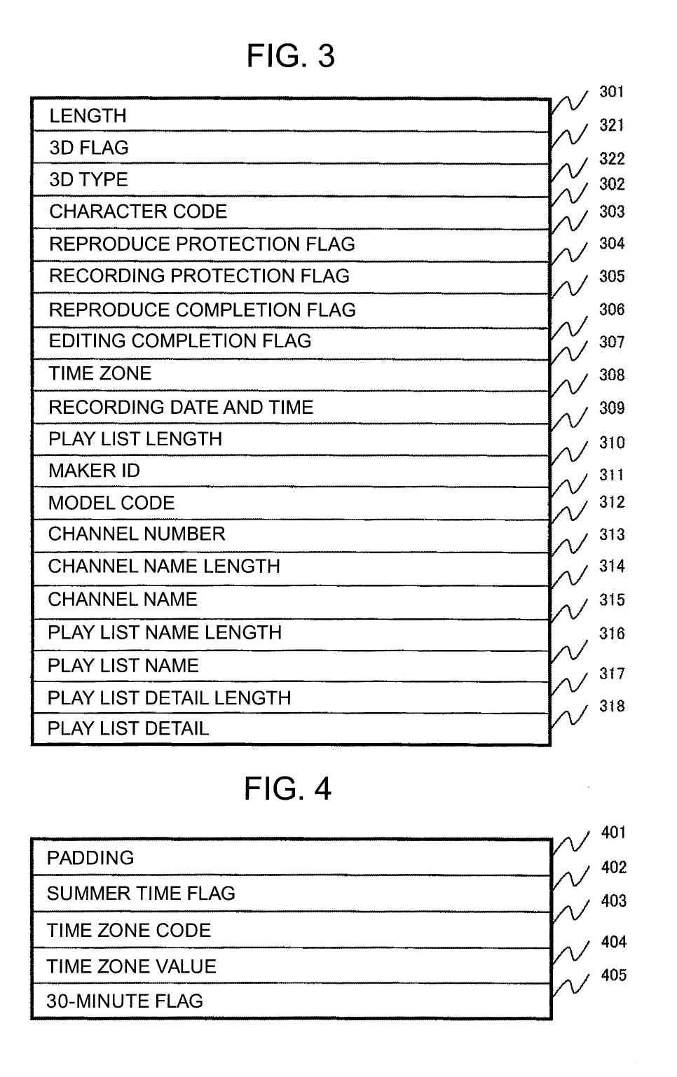

Reference numeral 206 denotes user interface application information having the data structure as shown in FIG. 3.

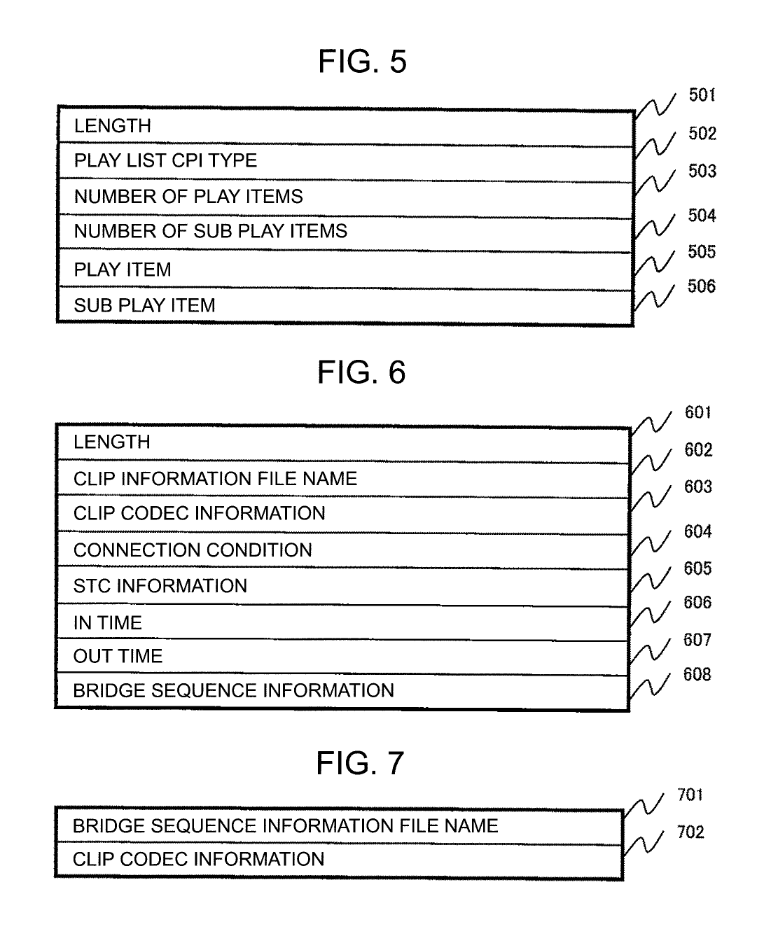

Reference numeral 207 denotes play list information having the data structure as shown in FIG. 5.

Reference numeral 208 denotes play list mark information.

Reference numeral 209 denotes maker unique data.

FIG. 3 shows an example of the structure of the user interface application information. Parameters for a user interface application of the play list are stored therein.

Reference numeral 301 denotes a length indicating the length of the user interface application information from immediately after this field to the end of the information.

Reference numeral 321 denotes a 3D flag. When 1 is set in the 3D flag, the 3D flag indicates that the contents contained in the play list include 3D (stereoscopic vision) contents. When 0 is set therein, the 3D flag indicates that 3D contents are not included.

Reference numeral 322 denotes a 3D type, which is combined with the 3D flag 321 to show a 3D system of contents contained in the play list. First, the case where 1 is set in the 3D flag 321 is described. At this time, when 00 is set in the 3D type 322, the flag indicates that the contents contained in the play list are a side-by-side system. When 01 is set in the 3D type 322, the flag indicates that the contents contained in the play list are a top-and-bottom system. When 10 is set in the 3D type 322, the flag indicates that the contents contained in the play list are a frame-packing system. When 11 is set in the 3D type 322, the flag indicates that the contents contained in the play list are another 3D system. Next, the case where 0 is set in the 3D flag 321 is described. In this case, the flag indicates that 3D contents are not contained regardless of a value set in the 3D type 322.

Reference numeral 302 denotes a character code which prescribes a character code used in a channel name 314, a play list name 316 and a play list detail 318. The character code is also applied to a character code of mark name of the play list mark information. For example, when 1 is set in the character code, Japanese is used and when 16 is set therein, ASCII code is used. When 32 is set therein, Unicode is used.

Reference numeral 303 denotes a reproduce protection flag. When 1 is set in the reproduce protection flag, play list information such as play list name and thumbnail and the play list are reproduced and are not displayed for a user. If authentication by inputting an identification number is successful, they can be reproduced. When 0 is set therein, they can be reprouduced without inputting the identification number.

Reference numeral 304 denotes a record protection flag. When 1 is set in the record protection flag, play list information except the record protection flag cannot be changed nor deleted. When 0 is set therein, the user can change and delete the play list information freely. When 1 is set therein, the recording device should make reconfirmation to the user before the user makes deletion, editing or overwriting of the play list information. The real play list having the record protection flag set to 0 and the virtual play list having the record protection flag set to 1 sometimes share the same part of clip. In this case, when the user tries to delete the real play list, the recording device should make reconfirmation to the user before deletion of the real play list.

Reference numeral 305 denotes a reproduce completion flag. When 1 is set in the reproduced completion flag, the flag indicates that the reproduce list has been reproduced at least once. When 0 is set therein, the flag indicates that the reproduce list has never been reproduced.

Reference numeral 306 denotes an editing completion flag. When 0 is set in the editing completion flag, the flag indicates that original data upon recording is preserved without being changed. When 1 is set therein, the flag indicates that the original data has been changed.

Reference numeral 307 denotes a time zone having the data structure as shown in FIG. 4.

FIG. 4 is a schematic diagram illustrating an example of the structure of the time zone.

Reference numeral 401 denotes padding for alignment.

Reference numeral 402 denotes a summer time flag. When 0 is set in the summer time flag, the flag indicates that it is standard time. When 1 is set therein, the flag indicates that it is summer time.

Reference numeral 403 denotes a time zone code. When 0 is set in the time zone code, the time zone code indicates a positive number. When 1 is set therein, the code indicates a negative number.

Reference numeral 404 denotes a time zone value indicating an absolute value of time in difference from UTC (coordinated universal time). The unit thereof is time (=60 minutes). When 15 is set in the time zone value, the time zone value is invalid and indicates that the summer time flag, the time zone code and 30-minute flag are also invalid.

Reference numeral 405 denotes the 30-minute flag. When 1 is set in the 30-minute flag, the flag indicates that the time zone value further has 30-minute additional difference time in an absolute value. When 0 is set therein, the flag indicates that the time zone value has no additional time.

Reference numeral 308 denotes recording date and time containing information of date and time at the time that the play list is recorded. The recording date and time is represented by local time. The year, month, date, hour, minute and second thereof are expressed by BCD (Binary Coded Decimal) of four bits representing one digit. The first four digits thereof correspond to four digits of the dominical year.

Reference numeral 309 denotes a play list length indicating the length of the play list in time unit. This is obtained by the total of reproduce time of play items contained in the play list. The reproduce time of the play item is time from IN time to OUT time. The unit thereof is rounded up to second. The hour, minute and second are expressed by BCD of four bits representing one digit.

Reference numeral 310 denotes a maker ID indicating a maker or manufacturer of the recording device having the play list updated last.

Reference numeral 311 denotes a maker model code indicating a model number of the recording device having the play list updated last.

Reference number 312 denotes a channel number, which is a broadcasting channel number or a service number selected by the user when the play list is recorded. In case of the play list obtained by joining two or more play lists, the value of the channel number indicates a representative value. This value is smaller than or equal to 999. When 0xFFFF is set, the channel number is invalid.

Reference numeral 313 denotes a channel name length indicating the byte length of the channel name. The channel name length is a value equal to or smaller than 20.

Reference number 314 denotes a channel name indicating a broadcasting channel name or a service name selected when the user records the play list. The byte length indicated by the channel name length 313 from the left end of this field is valid.

Reference number 315 denotes a play list name length indicating the byte length of the play list name. The play list name length has a value equal to or smaller than 255.

Reference numeral 316 denotes a play list name. The byte length indicated by the play list name length 315 from the left end of this field is valid.

Reference numeral 317 denotes a play list detail length indicating the byte length of the play list detail. The play list detail length has a value equal to or smaller than 1200.

Reference numeral 318 denotes a play list detail containing detailed text information of the play list. The byte length indicated by the play list detail length 317 from the left end of this field is valid.

FIG. 5 is a diagram showing an example of the structure of the play list information.

Reference numeral 501 denotes a length indicating the length from immediately after this field to the end of the play list information.

Reference numeral 502 denotes a play list CPI type, which is the type of the access point referred to from IN time or OUT time in the play item and is also the access point type of a mark time stamp in the play list mark. When 1 is set in the play list CPI type, the play list CPI type indicates that each access point in the play list information represents the display time in the AV stream file and is named as the play list information of EP_map type. When 2 is set therein, it indicates arrival time and is named as the play list information of TU_map type.

Reference numeral 503 denotes the number of play items indicating the number of play items in the play list. Play item ID is an integer starting from 0. The entries of the play items in the play list are sorted in order of display.

Reference numeral 504 denotes the number of sub play items indicating the number of sub play items in the play list.

FIG. 6 is a diagram showing an example of the structure of the play item.

Reference numeral 601 denotes a length indicating the length from immediately after this field to the end of the play item information.

Reference numeral 602 denotes a clip information file name indicating the name of the clip information file of the clip used in the play item information. This field shows 5-digit number zzzzz of a file name zzzzz.clpi expressed by a character string of ASCII code. A clip stream type field in the clip information file shows a clip AV stream file (MPEG-2 transport stream).

Reference numeral 603 denotes clip CODEC information. This field has a value indicating “M2TS” of ASCII code. All play items in the play list information have the clip CODEC information “MTS” of the same value. When the play list CPI type in the play list information is set to 1 and the clip CODEC information is set to “M2TS”, each clip used in the play list file has EP_map in the CPI information. When the play list CPI type in the play list information is set to 2 and the clip CODEC information is set to “M2TS”, each clip used in the play list file has TU_map in the CPI information.

Reference numeral 604 denotes a connection condition indicating the connection condition between IN time of the current play item and OUT time of the immediately previous play item. The connection condition is shown by any of values from 1 to 6. When the play item is a first play item in the play list, the connection condition field is invalid and 1 is set therein.

Reference number 605 denotes STC information. When the CPI type in the CPI information of the clip information file is EP_map, the STC information represents STC_ID of an STC sequence containing a presentation unit of the current play item. The clip being referred to by the clip information file name of the current play item has the STC sequence. The value of STC_ID is prescribed in the sequence information of the clip.

Reference numeral 606 denotes IN time indicating the IN time of the current play item, that is, the display start time of the current play item. The meaning of the IN time is different depending on the CPI type in CPI of the clip information file referred to by the clip information file name.

Reference numeral 607 denotes OUT time indicating the OUT time of the current play item, that is, the display end time of the current play item. The meaning of the OUT time is different depending on the CPI type in CPI of the clip information file referred to by the clip information file name.

In the case of EP_map, the IN time and the OUT time represent the display time based on the STC time of the clip used in the play item. Further, the time is measured in unit of 45-kHz clock. For example, the time is expressed by the higher 32 bits of 33-bit PTS of accuracy of 90 kHz with respect to the presentation unit. Moreover, a discontinuous point of system time is not contained from IN time to OUT time. Further, the OUT time indicates the time earlier than the IN time. However, when wraparound is carried out, the IN time becomes larger than the OUT time.

In the case of TU_map, the IN time and the OUT time represent the time of the same TU_time_base as that in the ATC sequence of the clip referred to by the clip information file name of the play item. Further, the IN time and the OUT time are measured by 45-kHz clock. Moreover, the OUT time is larger than the IN time.

Reference numeral 608 denotes bridge sequence information described later in detail with reference to FIG. 7.

FIG. 7 is a diagram showing an example of the structure of the bridge sequence information.

Reference numeral 701 denotes a bridge sequence information file name indicating the name of the clip information file of bridge clip used in the bridge sequence information. This field contains 5-digit numerical value (corresponding to zzzzz of the file name) described in ASCII code. The clip stream type in the clip information of the clip information file is a bridge clip AV stream (MPEG-2 transport stream).

Reference numeral 702 denotes clip CODEC information. The clip CODEC information has a value of “M2TS” in ASCII code and indicates that the play list file uses MPEG-2 transport stream. The bridge clip used in the bridge sequence information has EP_map in CPI.

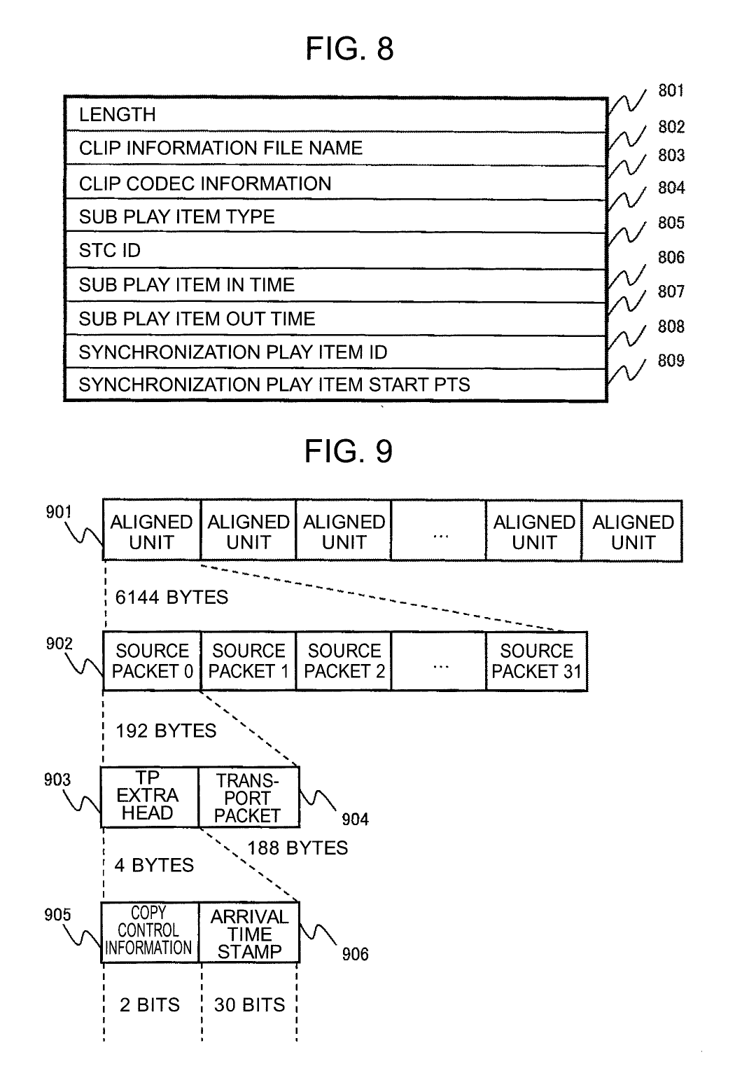

FIG. 8 is a diagram showing an example of the structure of the sub play item.

Reference numeral 801 denotes a length which is the byte length from immediately after this field to the end of the sub play item.

Reference numeral 802 denotes a clip information file name indicating the name of the clip information file of the clip used in the sub play item. This field has a 5-digit number in ASCII code corresponding to zzzzz of the name of the clip. The clip stream type in the clip information of the clip information file indicates “clip AV stream (MPEG-2 transport stream)”.

Reference numeral 803 denotes clip CODEC information having a value of “M2TS” in ASCII code and indicating that MPEG-2 transport stream is used in the play list file. The clip used in the sub play item has EP_map in CPI.

Reference numeral 804 denotes a sub play item type indicating the type of sub path used in the sub play item but only a value of 1 is set therein. The clip AV stream of audio stream for postrecording is used.

Reference numeral 805 denotes the STC_ID indicating the STC_ID corresponding to the STC sequence of the clip indicated by the clip information file name referred to by the sub play item. Both of the sub play item IN time and the sub play item OUT time of the sub play item indicate the presentation unit in the same STC sequence referred to by the STC_ID.

Reference numeral 806 denotes the sub play item IN time which has the display start time of the sub play item. The sub play item IN time is the display time measured from STC of the clip used in the sub play item with 45-kHz accuracy.

Reference numeral 807 denotes the sub play item OUT time which is the sub play item OUT time having the display end time of the sub play item. The sub play item OUT time is the display time measured from STC of the clip used in the sub play item with 45-kHz accuracy. The sub play item OUT time indicates the time earlier than the sub play item IN time and when STC is subjected to wraparound between the sub play item IN time and the sub play item OUT time, the sub play item IN time becomes larger than the sub play item OUT time. Both of the sub play item IN time and the sub play item OUT time indicate the display time in the section between the display start time and the display end time corresponding to the STC sequence referred to by STC_ID of the sub play item.

Reference numeral 808 denotes a synchronization play item ID indicating the play item ID of the play item in the play list. The play item contains the sub play item and reproduce of the sub play item is started within the reproduce time of the play item. The play item ID is decided by a play list in the play list.

Reference numeral 809 denotes a synchronization play item start PTS indicating the display time in the play item indicated by the synchronization play item ID. The sub play item starts to display the sub play item itself when the display time of the play item reaches the synchronization play item start PTS. The synchronization play item start PTS is the display time of the play item measured in 45-kHz clock of the play item indicated by the synchronization play item ID.

### Embodiment 2

### (Recording Device)

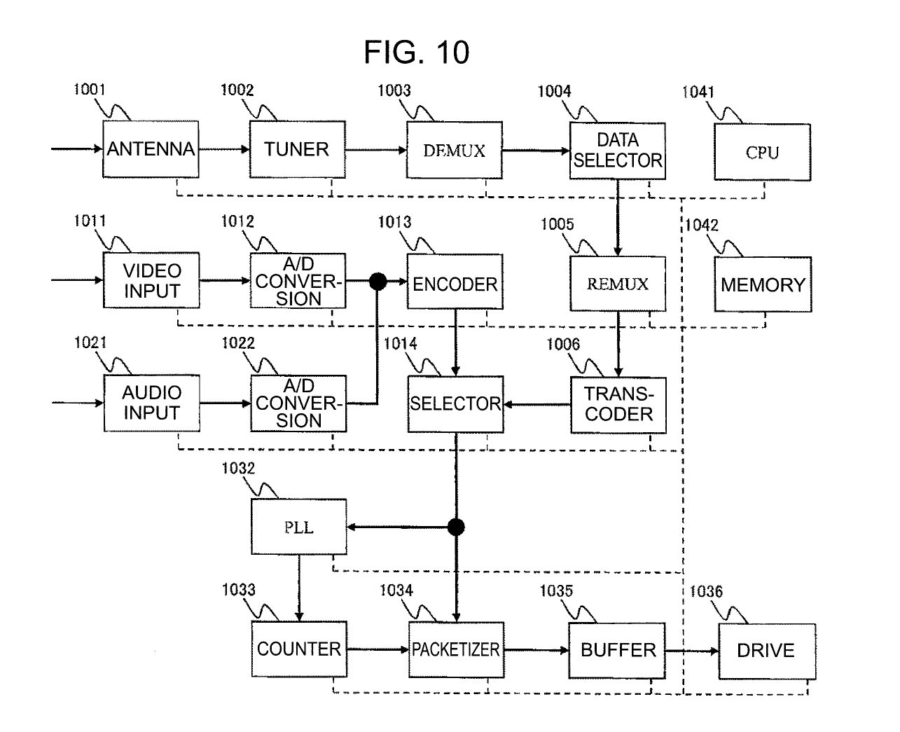

First, referring to FIGS. 9 and 10, the recording device is described.

FIG. 9 is a diagram showing an example of the structure of the MPEG-2 transport stream.

The AV stream file has the structure of the MPEG-2 transport stream. The MPEG-2 transport stream is composed of a natural number of aligned units 901. The aligned units 901 each have the size of 6144 bytes (=2048×3 bytes). The aligned units 901 start from a first byte of source packet 902. The source packet 902 has the length of 192 bytes. One source packet is composed of a TP extra header 903 and a transport packet 904. The TP extra header 903 has the length of 4 bytes and the transport packet 904 has the length of 188 bytes. One aligned unit 901 is composed of 32 source packets 902. The last aligned unit 901 of the MPEG-2 transport stream is composed of 32 source packets 902. Accordingly, the MPEG-2 transport stream is terminated at the end of the aligned unit 901. When the last aligned unit 901 is not all filled with the inputted transport stream, the remaining bytes are filled with transport packets of PID=0x1FFF, that is, source packets of null packets.

The transport packet 904 is prescribed by ISO/IEC 13818-1.

The TP extra header 903 includes copy permission information 905 and arrival time stamp 906. The copy permission information 905 contains content protection information of the related transport packet 904. The arrival time stamp 906 is set to a value of arrival time stamp described later.

FIG. 10 is a schematic diagram illustrating an example of the recording device showing a system of an embodiment of the present invention.

Reference numeral 1001 denotes an antenna which receives digital broadcasting waves.

Reference numeral 1002 denotes a tuner which receives the digital broadcasting waves inputted from the antenna 1001.

Reference numeral 1003 denotes DEMUX which separates the digital broadcasting waves (full TS (Transport Stream)) received by the tuner 1002 into elementary streams if necessary.

Reference numeral 1004 denotes a data selector which selects a necessary stream from the elementary streams separated by the DEMUX 1003 if necessary.

Reference numeral 1005 denotes REMUX which multiplexes the stream sent from the data selector to the MPEG-2 transport stream again if necessary to form partial TS (Transport Stream).

Reference numeral 1006 denotes a transcoder which transcodes or converts the format of audio stream and video stream of TS inputted from the REMUX 1005 if necessary.

Reference numeral 1011 denotes a video input to which an analog video signal is inputted.

Reference numeral 1012 denotes A/D conversion which converts analog data inputted from the video input 1011 into digital data.

Reference numeral 1021 denotes an audio input to which an analog audio signal is inputted.

Reference numeral 1022 denotes A/D conversion which converts analog data inputted from the audio input 1021 into digital data.

Reference numeral 1013 denotes an encoder which encodes the video data and the audio data digitized by the A/D conversions 1012 and 1022 into MPEG-2 transport stream.

Reference numeral 1014 denotes a selector which switches the stream sent from the transcoder 1006 or the encoder 1013 to be inputted.

Reference numeral 1031 denotes T_STD which is transport system target decoder to which MPEG-2 transport stream at time i is inputted.

Reference numeral 1032 denotes PLL which is synchronized with PCR (Program Clock Reference) of the inputted MPEG-2 transport stream at the frequency of 27 MHz.

Reference numeral 1033 denotes a counter which is a binary counter that counts a pulse signal having the frequency of 27 MHz. A count value i at time i is delivered to a packetizer 1034 as arrival time clock (i).

Reference numeral 1034 denotes the packetizer which adds TP extra header to all transport packets to produce source packet stream and aligned unit. The produced source packet stream is transferred to a write buffer 1035 at a maximum transfer rate RMAX. The packetizer 1034 has a small-capacity buffer therein and averages the bit rate of the stream. The peak rate of digital broadcasting sometimes exceeds RMAX, although the transfer rate to the write buffer 1035 is ensured to be equal to or smaller than RMAX by the internal buffer.

The arrival time stamp is the time at which the first byte of the source packet arrives at the T_STD 1031 and the packetizer 1034. The arrival time stamp (k) is a sample value of arrival time clock (k) (refer to the expression described below).

Arrival time stamp (k)=arrival time clock (k) % (2 to the 30th power)

The maximum value in difference between arrival time stamps of two consecutive packets is (230−1)/27000000 seconds (=about 40 seconds).

When the difference exceeds the value, the arrival time stamp is changed so that the difference is equal to the maximum value. The recording device is required to take such a case into consideration. When MPEG-2 transport stream player described later produces the transport steam according to the arrival time stamp, the PCR accuracy of the produced transport stream is prescribed by ISO/IEC 13818-9.

Reference numeral 1035 denotes a buffer which is a write buffer for writing the source packet transferred from the packetizer 1034 into a drive 1036. A TS recording rate defined in the clip information of the AV stream file decides the value of RMAX. The RMAX is calculated as follows.

RMAX=TS recording rate×192/188

The unit of TS recording rate is byte/second.

When the maximum recording rate of the drive is RUD and the buffer 1035 is not empty, the recording rate to the drive 1036 is RUD. When the buffer 1035 is empty, the recording rate to the drive 1036 is 0. The buffer 1035 does not overflow.

Reference numeral 1036 denotes the drive which writes the stream inputted from the write buffer 1035 into a recording medium such as an optical disk at the maximum recording rate RUD.

Reference numeral 1041 denotes a CPU which performs recording control of the entire recording device. The CPU is connected to respective blocks in the recording device through a CPU bus shown by broken line to perform transmission/reception and control of data.

Reference numeral 1042 denotes a memory which is used as work memory of the CPU 1041 or a buffer of the encoder.

### Embodiment 3

### (Reproducing Device)

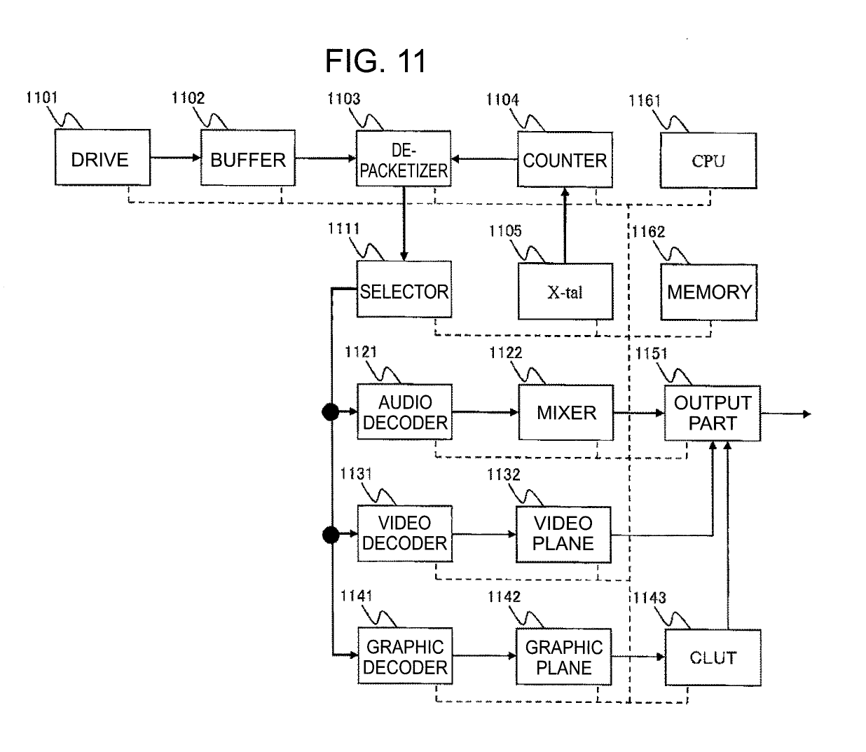

Next, referring to FIG. 11, the reproducing device is described.

FIG. 11 is a schematic diagram illustrating an example of the reproducing device showing a system of an embodiment of the present invention.

Reference numeral 1101 denotes a drive which reads out the MPEG-2 transport stream from the recording medium such as an optical disk to be transferred to a buffer 1102.

Reference numeral 1102 denotes the buffer which buffers the MPEG-2 transport stream read out by the drive 1101.

Reference numeral 1103 denotes a depacketizer which separates the MPEG-2 transport stream inputted from the buffer 1102 into the TP extra header and the transport packet and synchronizes the arrival time stamp with the arrival time clock inputted from a counter 1104 to produce the transport packet. An initial value of the arrival time clock is first delivered to the counter 1104.

Reference value 1104 denotes the counter which counts pulse signal of 27 MHz from X-tal 1105 starting from the initial value received from a depacketizer 1103 and delivers the arrival time clock to the depacketizer 1103.

Reference numeral 1105 denotes the X-tal which produces the pulse signal of 27 MHz.

Reference numeral 1111 denotes a selector which switches the transport packets received from the depacketizer 1103 for each type to be delivered to a relevant decoder.

Reference number 1121 denotes an audio decoder which decodes the audio packet received from the selector 111 to be delivered to a mixer 1122.

Reference numeral 1122 denotes the mixer which makes mixing of volume setting of multi-channel audio at a designated rate if necessary.

Reference numeral 1131 denotes a video decoder which decodes the video packet inputted from the selector 1111 to be delivered to a video plane 1132.

Reference numeral 1132 denotes the video plane which is a plane buffer which develops picture data decoded by the video decoder 1131 to be displayed.

Reference numeral 1141 denotes a graphic decoder which decodes graphic packet inputted from the selector 1111 to be delivered to a graphic plane 1142.

Reference numeral 1142 denotes the graphic plane which is a plane buffer which develops the graphic data inputted from the graphic decoder 1141.

Reference numeral 1143 denotes a CLUT (Color Look Up Table) which is a table for reference to RGB data and alpha blend data corresponding to pixels of the graphic plane 1142.

Reference numeral 1151 denotes an output part which multiplexes inputted audio/video/graphic data to be outputted from the reproducing device externally in analog format such as YCbCr or digital format such as HDMI.

Reference numeral 1161 denotes a CPU which controls reproducing of the whole reproducing device. The CPU is connected to respective blocks in the recording device through CPU bus shown by broken line to perform transmission/reception and control of data.

Reference numeral 1162 denotes a memory which is used as work memory of the CPU 1161, a buffer of the decoder and the like.

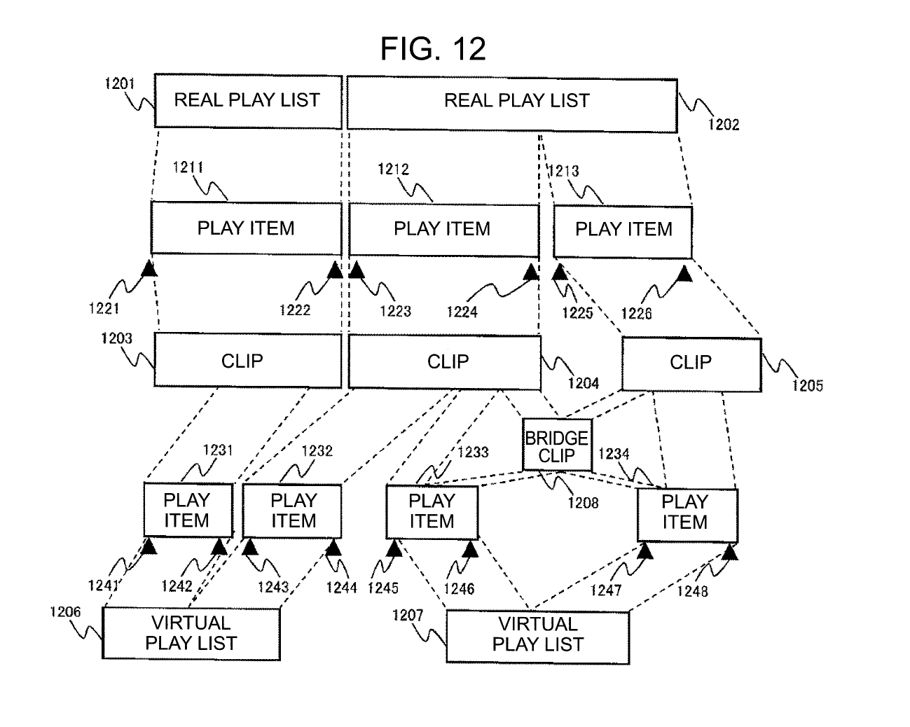

FIG. 12 is a schematic diagram illustrating an example of real play lists and virtual play lists showing a system of an embodiment of the present invention.

Reference numeral 1201 denotes a first real play list referring to a play item 1211.

Reference numeral 1202 denotes a second real play list referring to play items 1212 and 1213.

Reference numeral 1211 denotes the first play item referring to a clip 1203.

Reference numeral 1212 denotes the second play item referring to a clip 1204.

Reference numeral 1213 denotes a third play item referring to a clip 1205.

Reference numeral 1203 denotes the first clip.

Reference numeral 1204 denotes the second clip.

Reference numeral 1205 denotes the third clip.

Reference numeral 1231 denotes a fourth play item referring to part of the clip 1203.

Reference numeral 1232 denotes a fifth play item referring to part of the clip 1204.

Reference numeral 1233 denotes a sixth play item referring to part of the clip 1204 and part of a bridge clip 1208.

Reference numeral 1234 denotes a seventh play item referring to part of the bridge clip 1208 and part of the clip 1205.

Reference numeral 1206 denotes a first virtual play list referring to the play items 1231 and 1232.

Reference numeral 1207 denotes a second virtual play list referring to the play items 1233 and 1234.

Reference numeral 1208 denotes the first bridge clip which is re-encoded from data of an end part of the clip 1204 and data of a head part of the clip 1205.

The play list is described.

The play list enables the user to easily edit the reproducing time of clip that the user desires to reproduce. The play list enables cutting/pasting editing without movement, copying and deletion (including partial movement, partial copying and partial deletion) of the entity of clip files, for example. The play list is a collection of series of reproduce sections named play items in clips and the play item is represented by a set of IN point and OUT point. The IN point and the OUT point are time information indicating positions on a time axis owned by the clip. Accordingly, it can be said that the play list is a collection of play items. Further, the IN point means a reproduce start position of the reproduce section and the OUT point means a reproduce end position of the reproduce section. There are two kinds of play lists including the real play list and the virtual play list.

The real play list is described.

The real play list is used in the clip AV stream file but is not used in the bridge clip AV stream file. The real play list makes reference to the part where the clip is present.

The data space in the disk is consumed by the amount of size of (part of) the clip referred to by the reference made by the real play list and when the real play list is deleted, (part of) the clip referred to is deleted.

The virtual play list is described.

The real play list is used in both of the clip AV stream files and the bridge clip AV stream files. When the virtual play list is used in the clip AV stream file, the virtual play list does not have data entity but when the virtual play list is used in the bridge clip AV stream file, the virtual play list has data entity. When the virtual play list which does not use the bridge clip AV stream file is deleted, the clip is not changed.

On the other hand, when the virtual play list using the bridge clip AV stream file is deleted, the clip AV stream file and the clip information file related thereto are not changed but the bridge clip AV stream file and the clip information file related thereto are deleted.

The clip is a management unit for performing internal control of the reproduce device or the recording device and is not displayed in the user interface. Only the play list is displayed for the user.

Operations of the play list are given as follows.

Operations concerning operations of the real play list are given as follows.

### (1) Generation of Real Play List

The real play list generated when the program broadcasted first is recorded becomes a real play list referring to the entire recorded clip.

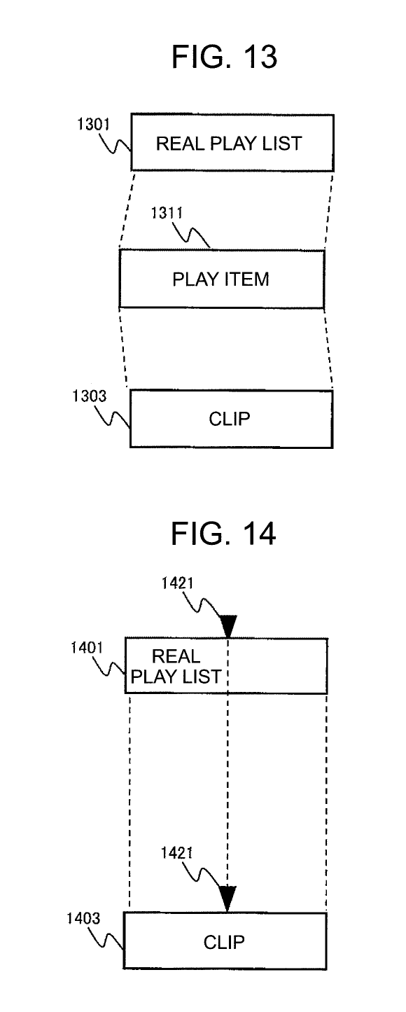

FIG. 13 is a diagram showing an example of generation of the real play list.

Reference numeral 1301 denotes a real play list which refers to a play item 1311. The real play list is generated as one play list file upon new recording.

Reference numeral 1311 denotes the play item which refers to a clip 1303.

Reference numeral 1303 denotes the clip which is generated as one clip information file and one AV stream file upon new recording.

### (2) Division of Real Play List

When one real play list is divided into two real play lists, no change occurs in the clip itself.

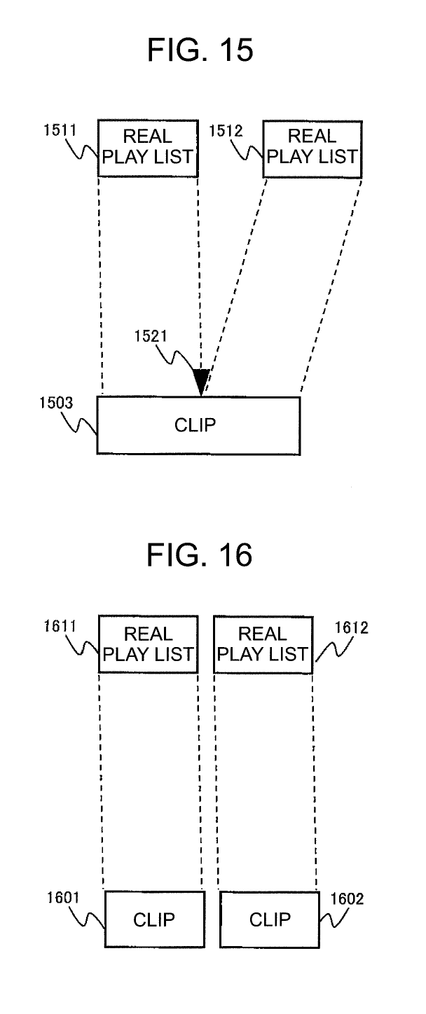

FIGS. 14 and 15 are diagrams showing an example of division of the real play list.

Reference numeral 1401 denotes a real play list which refers to a clip 1403 via a play item not shown.

Reference numeral 1403 denotes the clip.

Reference numeral 1421 denotes a division point, in which an example where the vicinity of the center of the real play list 1401 is divided is shown.

Reference numeral 1511 denotes a real play list which refers to part (corresponding the left part of a division point 1521) of a clip 1503 via a play item not shown.

Reference numeral 1503 denotes the clip which is the same as the clip 1403.

Reference numeral 1512 denotes a real play list which refers to part (corresponding to the right part of the division point 1521) of the clip 1503 via a play item not shown.

### (3) Connection of Real Play Lists

When two real play lists are connected to form one new real play list, no change occurs in the clip itself.

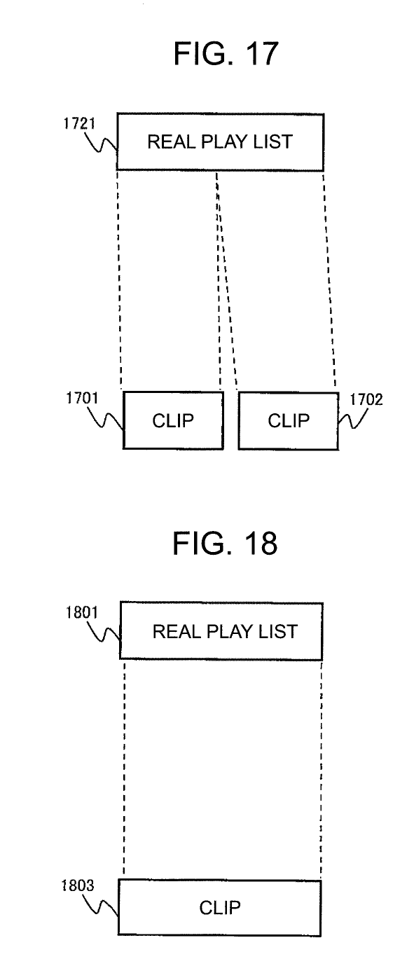

FIGS. 16 and 17 are diagrams showing an example of the connection of the real play lists.

Reference numeral 1611 denotes a real play list which refers to a clip 1601 via a play item not shown.

Reference numeral 1601 denotes the clip.

Reference numeral 1612 denotes a real play list which refers to a clip 1602 via a play item not shown.

Reference numeral 1602 denotes the clip.

Reference numeral 1701 denotes a clip which is the same as the clip 1601.

Reference numeral 1702 denotes a clip which is the same as the clip 1602.

Reference numeral 1721 denotes a real play list which refers to the clips 1701 and 1702 via a play item not shown.

### (4) Deletion of Entire Real Play List

When an entire real play list is deleted, the referred range of the clip referred to is deleted.

FIG. 18 is a diagram showing an example of deletion of a real play list.

Reference numeral 1801 denotes a real play list which refers to a clip 1803 via a play item not shown.

Reference numeral 1803 denotes the clip.

### (5) Deletion of Part of Real Play List

When part of a clip referred to by the real play list is deleted, a play item is changed to leave necessary part but part not referred to in the clip is deleted.

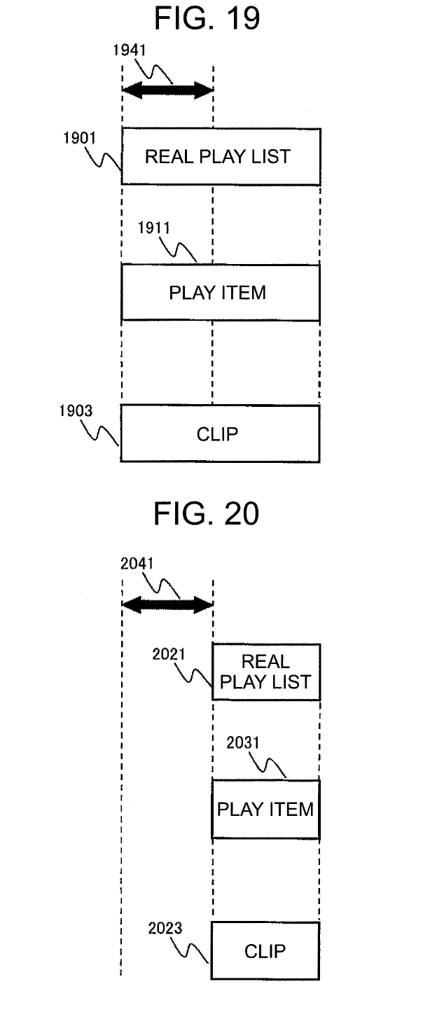

FIGS. 19 and 20 are diagrams showing an example of partial deletion of the head part of a real play list.

Reference numeral 1901 denotes a real play list which refers to a play item 1911.

Reference numeral 1911 denotes the play item which refers to a clip 1903.

Reference numeral 1903 denotes the clip.

Reference numeral 2021 denotes a real play list which refers to a play item 2031.

Reference numeral 2041 denotes a deletion range in which an example where the part corresponding to the left of the real play list 1901 is partially deleted is shown.

Reference numeral 2031 denotes the play item which refers to a clip 2023.

Reference numeral 2023 denotes the clip.

When the intermediate part of a clip AV stream is edited to be deleted, the remaining parts are connected to one clip file.

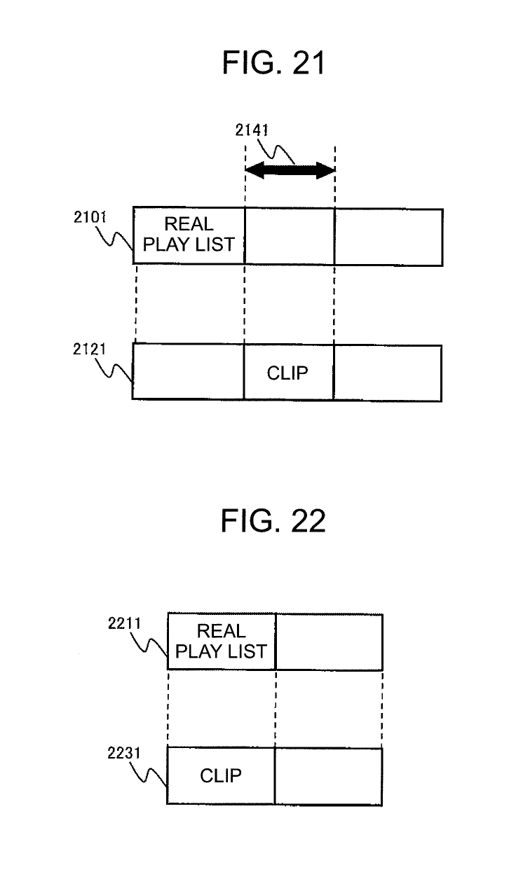

FIGS. 21 and 22 are diagrams showing an example of partial deletion of an intermediate part of a real play list.

Reference numeral 2101 denotes a real play list which refers to a clip 2121 via a play item not shown.

Reference numeral 2121 denotes the clip.

Reference numeral 2141 denotes a deletion range in which an example in which part corresponding to an intermediate area of the real play list 2101 is partially deleted (=middle part deletion) is shown.

Reference numeral 2211 denotes a real play list which refers to a clip 2231 via a play item not shown.

Reference numeral 2231 denotes the clip.

Operations concerning operations of the virtual play list are given as follows.

### (1) Assemble Editing

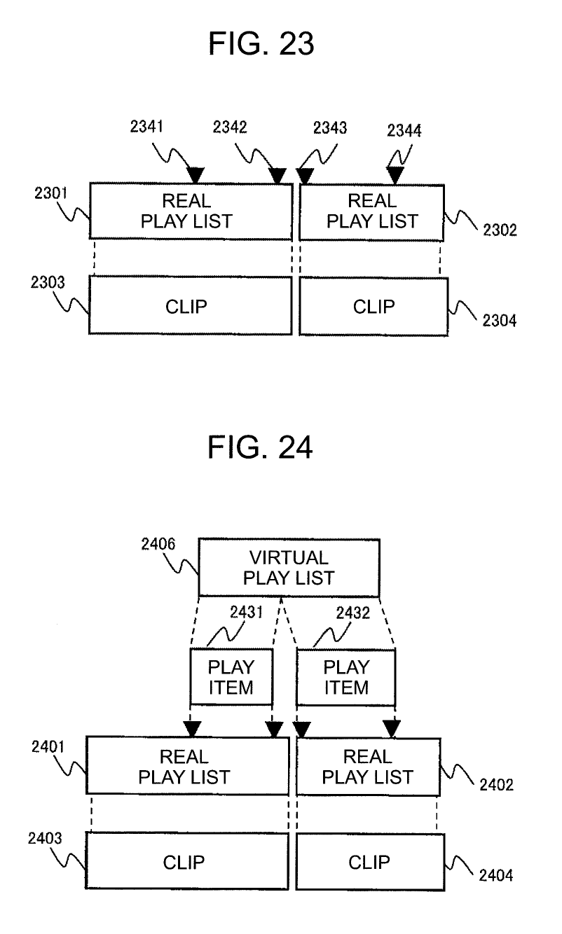

As shown in FIGS. 23 to 34, a play item which the user desires to reproduce can be generated and connected to another play item using a virtual play list.

A bridge clip file can be produced to thereby realize reproduce with smooth seam at a connection point. In order to connect MPEG video streams seamlessly to be reproduced, the reproduce is generally realized by re-encoding an extremely small number of pictures in the vicinity of the connection point and bridge-clipping them.

With this processing, it is not necessary to change the original clip AV stream file and the clip information file thereof.

FIGS. 23 and 24 are diagrams showing an example of the assemble editing (non-seamless connection of two play items)

Reference numeral 2301 denotes a real play list which refers to a clip 2303 via a play item not shown.

Reference numeral 2303 denotes the clip.

Reference numeral 2302 denotes a real play list which refers to a clip 2304 via a play item not shown.

Reference numeral 2304 denotes the clip.

Reference numeral 2341 denotes an IN point which is IN time of a play item 2431 registered in the virtual play list.

Reference numeral 2342 denotes an OUT point which is OUT time of the play item 2431 registered in the virtual play list.

Reference numeral 2343 denotes an IN point which is IN time of a play item 2432 registered in the virtual play list.

Reference numeral 2344 denotes an OUT point which is OUT time of the play item 2432 registered in the virtual play list.

Reference numeral 2406 denotes a virtual play list which refers to the play items 2431 and 2432.

Reference numeral 2431 denotes the play item which refers to part of a real play list 2401.

Reference numeral 2432 denotes the play item which refers to part of a real play list 2402.

Reference numeral 2403 denotes a clip which is the same as the clip 2303.

Reference numeral 2404 denotes a clip which is the same as the clip 2304.

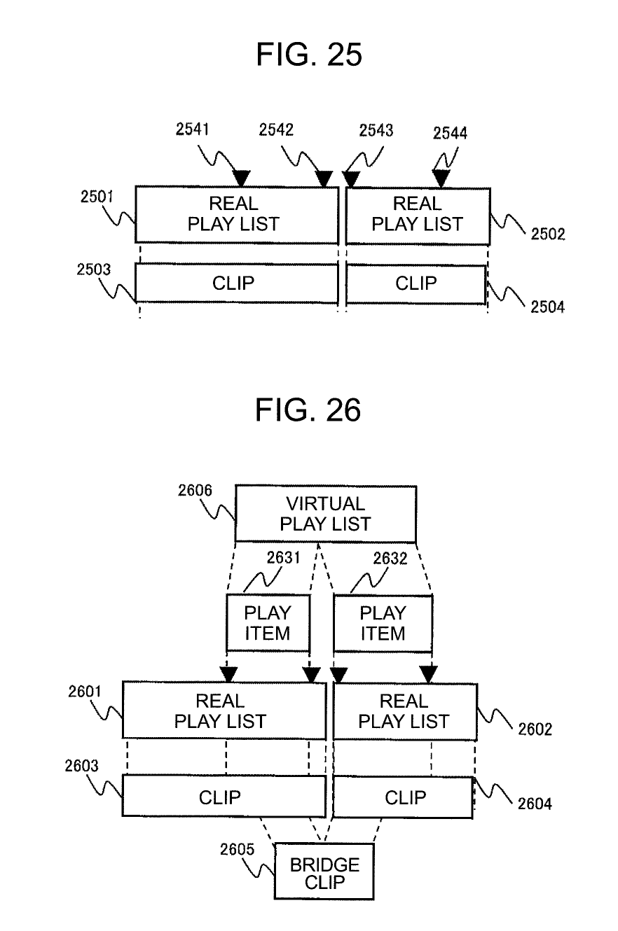

FIGS. 25 and 26 are diagrams showing an example of the assemble editing (seamless connection of two play items).

Reference numeral 2501 denotes a real play list which refers to a clip 2503 via a play item not shown.

Reference numeral 2503 denotes the clip.

Reference numeral 2502 denotes a real play list which refers to a clip 2504 via a play item not shown.

Reference numeral 2504 denotes the clip.

Reference numeral 2541 denotes an IN point which is IN time of a play item 2631 registered in a virtual play list.

Reference numeral 2542 denotes an OUT point which is OUT time of the play item 2631 registered in the virtual play list.

Reference numeral 2543 denotes an IN point which is IN time of a play item 2632 registered in the virtual play list.

Reference numeral 2544 denotes an OUT point which is OUT time of the play item 2632 registered in the virtual play list.

Reference numeral 2606 denotes a virtual play list which refers to the play items 2631 and 2632.

Reference numeral 2631 denotes the play item which refers to part of a real play list 2601.

Reference numeral 2632 denotes the play item which refers to part of a real play list 2602.

Reference numeral 2603 denotes a clip which is the same as the clip 2503.

Reference numeral 2604 denotes a clip which is the same as the clip 2504.

### (2) Re-Editing of Virtual Play List

There is considered an editing method in which a play item is added or inserted in a virtual play list or a play item in the virtual play list is deleted to thereby change IN point or OUT point of the play item in the virtual play list.

When the IN point and the OUT point referring to the bridge clip are changed by the user's operation, there is considered the processing in which the recording device warns the user that the existing bridge clip has to be deleted and a new bridge clip has to be generated to make confirmation of the user and then such processing is performed.

### (3) Deletion of Virtual Play List

The entire virtual play list is deleted.

### (4) Postrecording Editing in Virtual Play List

Additional voice (=postrecording) can be recorded in the virtual play list. The added voice can be added as sub path.

Operations common to the virtual play list and the real play list include the followings.

### (1) Change of Reproduce Order of Play Lists

The reproduce order of play lists is changed by changing a play list table in which the reproduce order of play lists is prescribed. The clip itself is not changed by this operation.

### Embodiment 4

### (Recording/Reproducing Device)

Next, an embodiment of the recording/reproducing device is described.

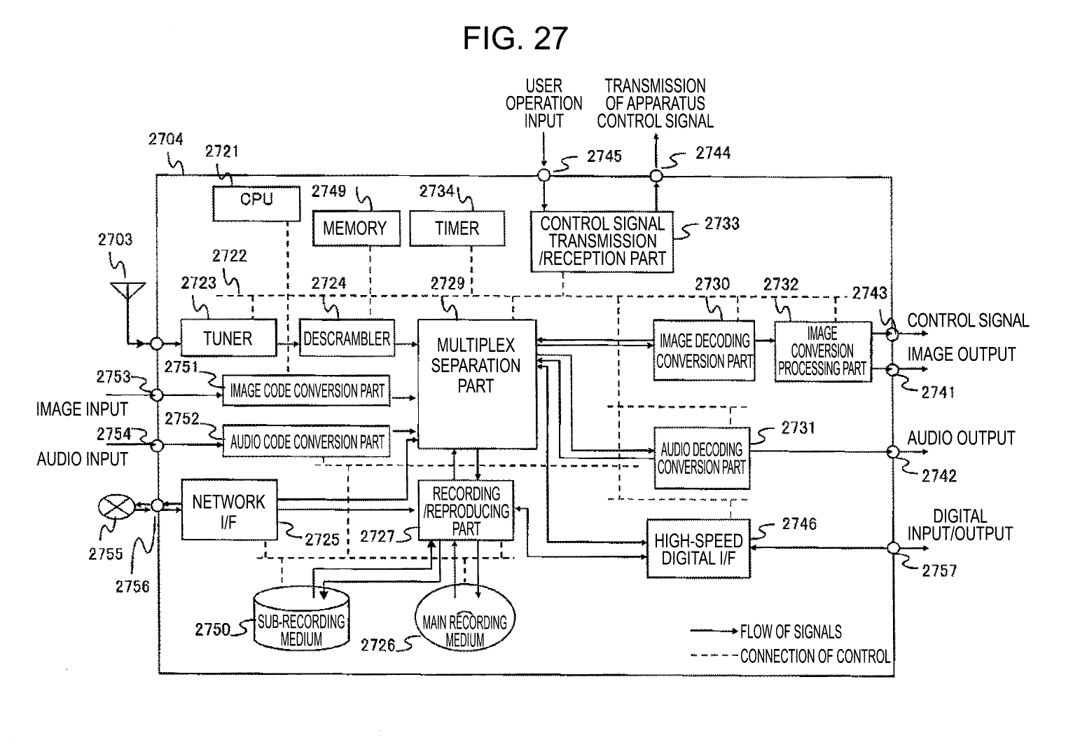

FIG. 27 is a schematic diagram illustrating an example of the hardware structure of the recording/reproducing device.

Reference numeral 2704 denotes a recording/reproducing device, 2703 an antenna which receives a broadcasting signal transmitted from a transmission apparatus through a broadcasting transmission network of radio (satellite and ground), cable or the like, 2721 a CPU (Central Processing Unit) which controls the whole of the recording/reproducing device, 2722 a general-purpose bus for transmitting control signals and information between the CPU 2721 and respective parts or devices in the recording/reproducing device, 2723 a tuner which receives the broadcasting signal transmitted from the transmission apparatus through the broadcasting transmission network of radio (satellite and ground), cable or the like and performs selection of a specific frequency, demodulation and error correction processing to output a multiplex packet such as MPEG2-Transport Stream (hereinafter abbreviated to “TS”), 2724 a descrambler which decodes scrambling of the broadcasting signal received from the tuner 2723, 2725 a network I/F (interface) which performs transmission and reception of information to a network 2755 installed outside of the device through a network terminal 2756 to perform transmission and reception of a variety of information and MPEG2-TS between the Internet and the recording/reproducing device, 2726 a main recording medium such as, for example, removable HDD, disk-type recording medium and flash memory, 2750 a sub-recording medium such as, for example, HDD (Hard Disk Drive) and flash memory installed in the recording/reproducing device or removable HDD, disk-type recording medium and flash memory, 2727 a recording/reproducing part which controls the main recording medium 2726 and the sub-recording medium 2750 to control recording of data in the main recording medium 2726 and the sub-recording medium 2750 and reproducing of data from the main recording medium 2726 and the sub-recording medium 2750, and 2729 a multiplex separation part which separates data multiplexed to a format such as MPEG2-TS into data such as image ES (Elementary System), audio ES, program information, subtitle information and graphic data or multiplexes data such as image ES and audio ES to a format such as MPEG2-TS. The ES represents compressed and coded image and audio data. Reference numeral 2730 denotes an image decoding conversion part which decodes image ES into image data or converts image ES into image ES of another format, 2731 an audio decoding conversion part which decodes audio ES into audio data to be outputted from audio output 2742 or converts audio ES into audio ES of another format to be outputted to the multiplex separation part 2729, 2732 an image conversion processing part which performs conversion processing such as conversion of image data decoded in the image decoding conversion part 2730 into 2D image data from 3D image data in accordance with an instruction of the CPU and conversion of 2D image data into 3D image data and further performs processing of superimposing display such as OSD (On Screen Display) of 2D or 3D prepared by the CPU 2721 on image data and processing of conversion into a predetermined format such as HDMI to output the processed image data to an image signal output part 2741 and output a synchronization signal and a control signal (used in control of apparatus) corresponding to the format of the processed image data from the image signal output part 2741 and a control signal output part 2743, 2733 a control signal transmission/reception part which receives an operation input (for example, a key code from a remote controller which transmits IR (Infrared Radiation) signal) from a user operation input part 2745 and transmits an apparatus control signal (for example, IR) to an external apparatus produced by the CPU 2721 or the image conversion processing part 2732 from an apparatus control signal transmission part 2744, 2734 a timer having a counter therein and holding the present time, and 2746 a high-speed digital I/F such as a serial interface and IP interface which subjects TS reconstructed by the multiplex separation part to necessary processing such as encryption to output the TS from a digital input/output terminal 2757 to the outside or decodes TS received externally through the digital input/output part 2757 to be inputted to the multiplex separation part 2729. The recording/reproducding device is constituted of these parts or devices mainly.

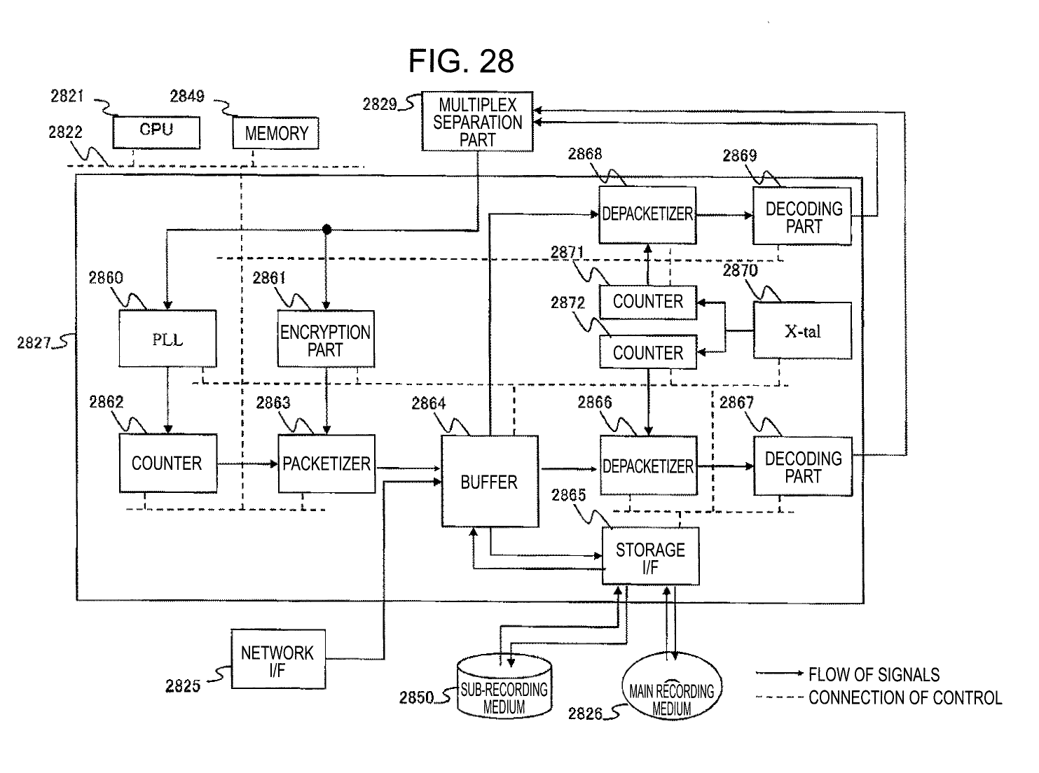

FIG. 28 is a diagram illustrating an example of the detailed hardware structure of the recording/reproducing part 2727 in the recording/reproducing device shown in FIG. 27.

Reference numeral 2827 denotes the recording/reproducing part 2727 of FIG. 27.

Reference numeral 2821 denotes the CPU 2721 of FIG. 27.

Reference numeral 2811 denotes the multiplex separation part 2711 of FIG. 27.

Reference numeral 2825 denotes the network I/F 2725 of FIG. 27.

Reference numeral 2826 denotes the main recording medium 2726 of FIG. 27.

Reference numeral 2850 denotes the sub-recording medium 2750 of FIG. 27.

Reference numeral 2860 denotes a PLL having the frequency of 27 MHz which is synchronized with PCR (Program Clock Reference) of MPEG-2TS inputted from the multiplex separation part 2829.

Reference numeral 2861 denotes an encryption part which encrypts MPEG-2TS inputted from the multiplex separation part 2829 by AES (Advanced Encryption System).

Reference numeral 2862 denotes a counter which counts the pulse signal of 27 MHz inputted from the PLL.

Reference numeral 2863 denotes a packetizer which divides MPEG2-TS inputted from the encryption part 2861 into data of a fixed length and adds a header containing arrival time stamp produced on the basis of the count value inputted from the counter thereto to be outputted as a fixed-length packet.

Reference numeral 2864 denotes a write buffer in which the packet inputted from the packetizer 2863 is stored temporarily. Further, the write buffer 2864 also temporarily stores data downloaded from a network through the network I/F 2825. Moreover, the write buffer 2864 is also a read buffer in which reproduce data inputted from a storage I/F 2865 is stored temporarily.

Reference numeral 2865 denotes the storage I/F which transfers data to the main recording medium 2826 and the sub-recording medium 2850 through the buffer 2865. The storage I/F 2865 is connected to the main recording medium 2826 and the sub-recording medium 2850 through a data bus such as SATA (Serial ATA) bus to transfer data in accordance with SATA protocol.

Reference numerals 2866 and 2868 denote depacketizers which separate MPEG-2 transport streams inputted from the buffer 2864 into TP extra header and transport packet and synchronize the arrival time stamp with the arrival time clock inputted from the counter 2872 to output transport packets.

Reference numerals 2867 and 2869 denote decoding parts which decode encrypted transport packets.

Reference numeral 2870 denotes a X-tal which produces the pulse signal of 27 MHz.

Reference numerals 2871 and 2872 denote counters which start counting of the pulse signal of 27 MHz from the X-tal 2870 from initial value received from the depacketizers 2866 and 2868 and deliver the arrival time clock to the depacketizers 2866 and 2868.

Further, although not shown in FIG. 28, input/output of data through the high-speed digital I/F 2746 in FIG. 27 is performed similarly to the network I/F 2825 so that digital data inputted from the high-speed digital I/F 2746 is temporarily stored in the buffer 2864 to be recorded in the main recording medium 2826 or the sub-recording medium 2850 and the digital data reproduceed from the main recording medium 2826 or the sub-recording medium 2850 is temporarily stored in the buffer 2864 to be outputted from the high-speed digital I/F 2746.

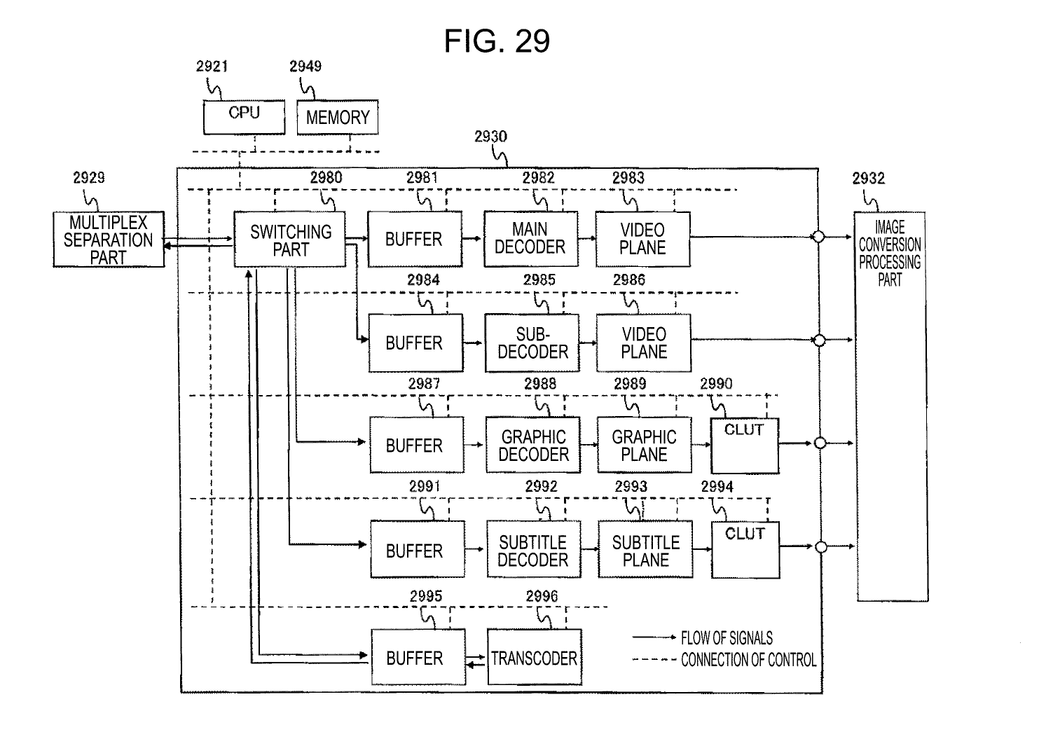

FIG. 29 is a diagram illustrating an example of the detailed hardware structure of the image decoding conversion part 2730 in the recording/reproducing device shown in FIG. 27.

Reference numeral 2921 denotes the CPU part 2721 of the FIG. 27.

Reference numeral 2949 denotes the memory 2749 of FIG. 27.

Reference numeral 2929 denotes the multiplex separation part 2729 of FIG. 27.

Reference numeral 2932 denotes the image conversion processing part 2732 of FIG. 27.

Reference numeral 2930 denotes the image decoding conversion part 2730 of FIG. 27.

Reference numeral 2980 denotes a switching part which has the function of a PID filter which distributes transport packets inputted from the multiplex separation part 2929 to set blocks in accordance with PID to be transferred.

Reference numerals 2981, 2984, 2987, 2991 and 2995 denote buffers which buffer transport packets inputted/outputted through the switching part 2980 temporarily.

Reference numeral 2982 denotes a main decoder which decodes transport packet of code-compressed image stream inputted through the buffer 2981.

Reference numeral 2983 denotes a video plane which is a display plane buffer which develops image data decoded by the main decoder 2982.

Reference numeral 2985 denotes a sub-decoder which decodes transport packet of code-compressed image stream inputted through the buffer 2984.

Reference numeral 2986 denotes a video plane which is a display plane buffer which develops image data decoded by the sub-decoder 2985.

Reference numeral 2988 denotes a graphic decoder which decodes transport packet of graphic data inputted through the buffer 2987.

Reference numeral 2989 denotes a graphic plane which is a plane buffer which develops graphic data decoded to be drawn by the graphic decoder 2988.

Reference numeral 2990 denotes a CLUT which performs conversion processing for replacing the graphic data developed in the graphic plane 2989 by display data.

Reference numeral 2992 denotes a subtitle decoder which decodes transport packet of subtitle data inputted through buffer 2991.

Reference numeral 2993 denotes a subtitle plane which is a plane buffer which develops graphic data decoded to be drawn by the subtitle decoder 2992.

Reference numeral 2994 denotes a CLUT which performs conversion processing for replacing the subtitle data developed in the subtitle plane 2993 by display data.

Reference numeral 2996 denotes a transcoder which transcodes transport packet of code-compressed image stream inputted through the buffer 2995 into image stream of another format or another bit rate to be outputted to the buffer 2995 again.

Data outputted from the video planes 2983 and 2986 and the CLUT's 2990 and 2994 are transferred to the image conversion processing part 2932.

The recording operation of the embodiment is described.

The state in which a channel to be video-recorded has been already selected before start of video recording is considered as an initial state.

In this state, the digital broadcasting waves received by the tuner 2723 through the antenna 2703 are de-scrambled by the descrambler 2724 and are separated by the multiplex separation part 2729 into image stream, audio stream, other graphic stream, subtitle stream and the like to be transferred to the decoder for each stream.

The image decoding conversion part 2730 extends image stream and the image conversion processing part 2732 converts image data if necessary, so that control signal and image output are outputted from the output terminals 2732 and 2741, respectively.

As described above, the outputted image output can be displayed in a monitor display connected to the recording/reproducing device, so that the user can look at and listen to it.

Next, the processing of starting recording operation by starting recording by the recording device in response to depression of a recording button by the user or at programmed recording start time is described in detail.

When the user depresses the recording button, a control signal representing recording start is inputted from the user operation input part 2745 and is received by the control signal transmission/reception part 2733. The received control signal is stored in buffer 2749 temporarily and is interpreted by the CPU 2721 to thereby perform control for starting recording operation.

At the same time, the CPU 2721 informs the user that the user's input is received correctly and recording is started using OSD (On Screen Display) or the like.

The CPU 2721 controls the multiplex separation part 2729 to transfer a stream of the program which the user selects and instructs to record to the recording/reproducing part 2727.

As shown in FIG. 28, the recording/reproducing part 2827 subjects the stream data inputted from the multiplex separation part 2829 to encryption processing of AES (Advanced Encryption System) or the like in the encryption part 2861 and to packetization processing in the packetizer 2863 to be stored in the buffer 2864 temporarily. Further, the pulse signal synchronized with PCR of the stream inputted from the multiplex separation part 2829 in the PLL 2860 is counted by the counter 2862 to be transferred to the packetizer 2863 and added to the transport packet as the arrival time clock of TP extra header.

The packet stored in the buffer 2864 is recorded in the main recording medium 2826 such as DVD and Blu-ray Disc™ by the storage IF 2865. At this time, the image stream and audio stream are recorded as m2ts file in the file structure as shown in FIG. 1.

For example, the stream file name becomes “01000.m2ts”.

Further, when the recording is ended, a clip information file, a real play list file, an info.bdav file and the like are recorded in the main recording medium 2826.

For example, the clip information file becomes “01000.clpi” and the real play list file becomes “01001.rpls”.

The recording start time and the recording end time of the stream file 146 are recorded in the IN time 606 and the OUT time 607 of the clip information file “01000.clpi”, respectively.

“01000” is recorded in the clip information file 602 of the real play list file “01001.rpls”.

When only one clip is recorded, “1” is recorded in the number of play items 503.

In the mode in which the image stream and the audio stream contained in the broadcasting waves are recorded as they are, the streams are transferred from the multiplex separation part 2729 to the recording/reproducing part 2727 of FIG. 27 as they are as described above, although when the format of the streams is converted into H.264 or Dolby Digital™ to be recorded, the streams are transferred from the multiplex separation part 2729 to the image decoding conversion part 2730 and stored in the buffer 2995 through the switching part 2980 shown in FIG. 29 in the image decoding conversion part 2730. Then, the format of the streams is converted by the transcoder 2996 and the streams are further returned to the multiplex separation part 2729 of FIG. 27 through the buffer 2995 and the switching part 2980. The returned stream data is transferred to the recording/reproducing part 2727 and recorded in the main recording medium 2726 in the same manner as the above.

The contents downloaded from a network are sometimes recorded in the main recording medium 2726 or the sub-recording medium 2750 even except that the broadcasting waves are recorded.

When the recording/reproducing device is connected to the network 2755 installed outside of the device through the network terminal 2756, a program (for example, JAVA™ program) included in the main recording medium 2726 is loaded and is executed by the CPU 2721. When the program is described to make access to the network, the recording/reproducing device can be connected to the Web site designated in the program and download new contents.

The downloaded contents are transferred to the recording/reproducing part 2727 through the network I/F 2725 to be recorded in the sub-recording medium 2750.

Further, digital data is sometimes inputted by the digital I/F 2746 through the digital input/output 2757 to be recorded in the main recording medium 2726 or the sub-recording medium 2750.

When the digital input/output 2757 of the recording/reproducing device is USB (Universal Serial Bus) or IEEE1394, a storage device such as, for example, a digital video camera, a digital still camera, an external HDD and USB flash memory, provided with the same digital I/F can be connected thereto to input digital data.

Alternatively, when the digital input/output 2757 has a slot for SD Card™, the SD card in which contents are recorded can be inserted in the slot to thereby directly input digital data from the SD card.

For example, in the case of a video camera or a digital camera coping with AVCHD™, USB can be connected and the compressed digital data recorded in H.264 format can be inputted to the recording/reproducing device from an HDD, a flash memory or an optical disk included in the camera to be recorded in the main recording medium 2726 or the sub-recording medium 2750.

It can be judged from SI information contained in the broadcasting waves, program information in the Internet or content information inputted by the user from a remote-controller whether the contents to be recorded are 3D or not and which system the 3D system of the contents to be recorded is, the side-by-side system or the top-and-bottom system or the frame-packing system or another system.

Information as to whether the contents to be recorded are 3D and what the 3D system is recorded in the real play list file produced upon recording of the contents. At this time, the information is recorded in the 3D flag 321 and the 3D type 322.

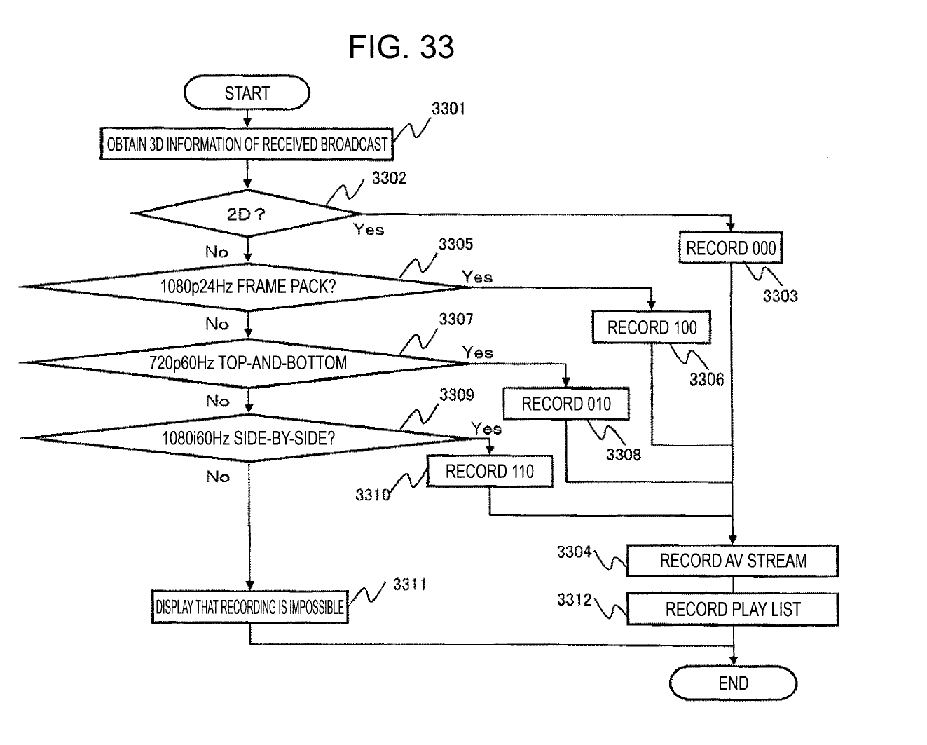

Referring to FIG. 33, the processing flow of recording the 3D type 322 is described.

When the recording/reproducing device receives broadcasting, information indicating 3D or 2D is obtained from the program information contained in the received broadcasting data (step 3301). When the information indicates 2D (step 3302), 000 is recorded as a value set in the 3D type 322 (step 3303). Then, AV stream is recorded (step 3304) and play list is recorded (step 3312). When the information does not indicate 2D but indicates 3D (step 3302), it is judged whether the 3D system is 1080p24 Hz frame pack or not (step 3305). When the 3D system is 1080p24 Hz frame pack (step 3305), 100 is recorded as the value set in the 3D type 322 (step 3306). When the 3D system is not 1080p24 Hz frame pack (step 3305), it is judged whether the 3D system is 760p60 Hz top-and-bottom or not (step 3307). When the 3D system is 760p60 Hz top-and-bottom (step 3307), 010 is recorded as the value set in the 3D type 322 (step 3308). Then, the AV stream is recorded (step 3304) and the play list is recorded (step 3312). When the 3D system is not the 760p60 Hz top-and-bottom (step 3307), it is judged whether the 3D system is 1080i60 Hz side-by-side or not (step 3309). When the 3D system is 1080i60 Hz side-by-side (step 3309), 110 is recorded as the value set in the 3D type 322. Then, the AV stream is recorded (step 3304) and the play list is recorded (step 3312). When the 3D system is not the 1080i60 Hz side-by-side (step 3309), it is displayed to the user that recording is impossible (step 311).

As described above, the 3D type of the contents can be recorded correctly and when recording is impossible, the user can be informed that recording is impossible.

Reproducing operation of the embodiment is described.

When an optical disk is loaded in the recording/reproducing part 2727 as the main recording medium of FIG. 27, insertion of the disk is informed from the recording/reproducing part 2727, so that the CPU 2721 instructs the recording/reproducing part 2727 to access the disk and performs recognition of the disk, confirmation as to whether automatic reproducing is required or not and the like.

Thereafter, a list of contents recorded in the disk is read out and the list of contents is displayed in the display connected to the recording/reproducing device.

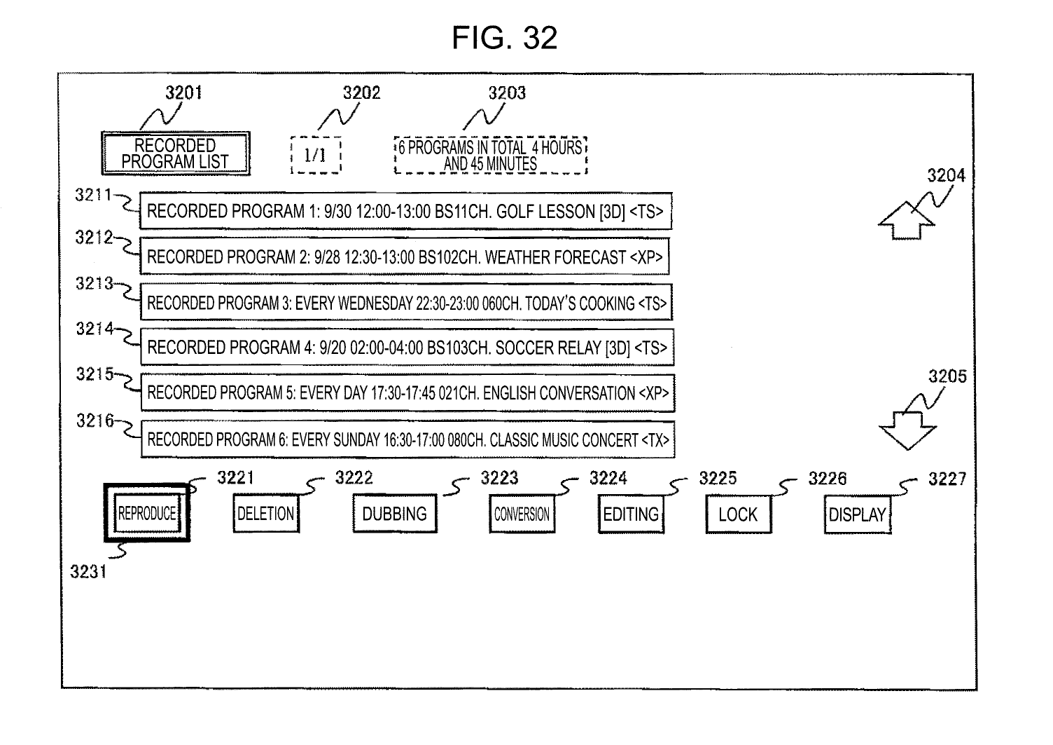

An example of the list of contents recorded by the user is shown in FIG. 32.

FIG. 32 is a schematic diagram illustrating an example of a picture in which a list of programs recorded in the disk by the user is displayed.

Reference numeral 3201 denotes a title display part of this picture in which the list of recorded programs is displayed.

Reference numeral 3202 denotes a page number display part which shows that there is one page in total for the list of recorded programs and a first page thereof is displayed.

Reference numeral 3203 denotes a display part for the total number of contents and the total recording time of contents. In this case, it is shown that 10 programs are recorded in total and the total time thereof is 4 hours and 15 minutes.

Reference numeral 3204 denotes a scroll up button. The recorded programs displayed in the list are scrolled up by depressing this button using a cursor or the like by the user's operation of a remote controller or the like.

Reference numeral 3205 denotes a scroll down button which is used to make reverse operation to the scroll up button.

Reference 3211 denotes an information display part of a recorded program 1. In this example, it displays that recording date and time is 1200 to 1300 hours on September 30, broadcasting channel is BS 11 channel, program name is “Golf Lesson”, program is 3D contents and recording mode is TS mode.

Reference numeral 3212 denotes the information display part of a recorded program 2.

Reference numeral 3213 denotes the information display part of a recorded program 3.

Reference numeral 3214 denotes the information display part of a recorded program 4.

Reference numeral 3215 denotes the information display part of a recorded program 5.

Reference numeral 3216 denotes the information display part of a recorded program 6.

Reference numeral 3221 denotes a menu list of the reproducing function. When this menu list is selected, the recorded program can be reproduced continuously.

Reference numeral 3231 denotes a selection box which shows an item selected when the user uses a user interface such as a remote controller to select a certain item among the items displayed in the picture. In this case, the state that “reproducing function” is selected is shown.

Reference numeral 3222 denotes a menu list of deletion function. When this menu list is selected, a recorded program can be deleted.

Reference numeral 3223 denotes a menu list of dubbing function. When this menu list is selected, a recorded program can be dubbed.

Reference numeral 3224 denotes a menu list of conversion function. When this menu list is selected, a recorded program can be converted.

Reference numeral 3225 denotes a menu list of editing function. When this menu list is selected, a recorded program can be deletion-locked.

Reference numeral 3227 denotes a menu list of display function. When this menu list is selected, recorded programs can be displayed in a list.

In FIG. 32, a program of interest is selected from the displayed recorded programs 3211 to 3216 by a remote controller or the like and “reproducing function” is selected to start reproducing.

Alternatively, when the disk is inserted into the recording/reproducing device, fast play can be performed or automatic reproduce such as resumption play in which reproduce is resumed from the position where the last reproduce is ended can be performed.

In the resumption play, resumption point list information having a disk ID and the final reproduce position paired is stored in a non-volatile memory of the recording/reproducing device upon extraction of disk and when the disk ID of an inserted disk is recognized upon insertion of the disk, the resumption point list is referred to. When there is an identical disk ID, the final reproducer position corresponding to the disk ID is judged as the reproduce resumption position and operation is jumped to the final reproduce position to start reproducing.

Alternatively, a file name of the play list desired to make resumption play is registered in a resumption play list file name ofinfo.bdav file 111 and the info.bdav file 111 is read out upon insertion of disk, so that the play list file recorded in the resumption play list file name can be reproduced to realize the resumption play.

In addition to the fast play and the resumption play, a recorded program list display function of the recording/reproducing device can be used to select the scene or contents desired to be reproduced by the user from a thumbnail list displayed therein.

For example, when the play list file 141 (01001.rpls) of FIG. 1 is reproduced, the play list information start address 203 is first read out of the structure of the play list file of FIG. 2 to obtain an offset on the file in which the play list information is stored. Next, when the play list information is read out from a position sought by the offset from the head of the play list file, the play list information of FIG. 5 is obtained. The play item 505 of this structure has the structure of FIG. 6 and when the clip information file 602 is referred to, the clip information file name to be reproduced can be understood. For example, when “01000” is recorded in the clip information file 602, it is understood that the clip information file 144 (01000.rpls) and the stream file (01000.rpls) can be read out. Further, when the IN time 606 and the OUT time 607 are referred to, the reproduce start position and the reproduce end position of the clip to be reproduced can be understood. This operation can be repeated by the number recorded in the play item number 503, so that it can be obtained which part of which clip should be reproduced in order.

Moreover, information such as the 3D flag 321, the 3D type 322, the recording date and time 308, the channel number 312 and the play list name 316 recorded in the play list file and a variety of information such as the bit rate, image resolution degree and CODEC information recorded in the clip information file can be read out to thereby obtain not only the image audio data itself but also a variety of attribute information. The obtained attribute information, for example, can be graphically processed by the image conversion processing part 2732 in accordance with instructions of the CPU 2721 and be converted into image data to be superimposed on main image outputted from the image decoding conversion part 2730 and be outputted from the image output 2741 to the outside of the device, so that the information can be transmitted to the display to be informed to the user.

Alternatively, information such as the 3D flag 321 and the 3D type 322 is encoded into control signal by the image conversion processing part 2732 in accordance with instructions of the CPU 2721 to be outputted from the control signal output part 2743.

The control signal outputted from the control signal output part 2743 and the image signal outputted from the image signal output part 2741 are supplied to the display connected to the outside of the recording/reproducing device as signals conforming to the digital image transmission standards (for example, HDMI standards (registered trademark) or Display Port standards (registered trademark)).

The display can receive the control signal outputted from the control signal output part 2743 and can correctly display the image signal outputted from the image signal output part 2741 by setting a display mode in accordance with the control signal.

An example of processing of the recording/reproducing device and the display in the embodiment is described.

The recording/reproducing device can obtain display information through the control signal output part 2743 from the display connected externally and interpret the information in accordance with instructions of the CPU 2721 to thereby recognize specifications and performance of the display. For example, the display information contains information as to whether the display can cope with 3D display and which system the display can cope with among 3D systems.

The recording/reproducing device compares the display information obtained and interpreted as described above with information such as the 3D flag 321 and the 3D type 322, so that the recording/reproducing device can judge whether 3D contents can be displayed in a three-dimensional manner correctly. When the 3D contents cannot be displayed in the three-dimensional manner correctly, the device can inform the user to that effect.

For example, when the 3D flag 321 and the 3D type 322 recorded in the play list file of the contents to be reproduced are 1 and 10, respectively, and the connected display can copes with only the three-dimensional display of the side-by-side system, the contents to be reproduced are 3D contents recorded in the frame packing system and the display cannot cope with display of the frame packing system. Accordingly, the contents cannot be displayed in the three-dimensional manner correctly. Hence, a message that “the contents cannot be displayed in this display” is issued in the display to be informed to the user.

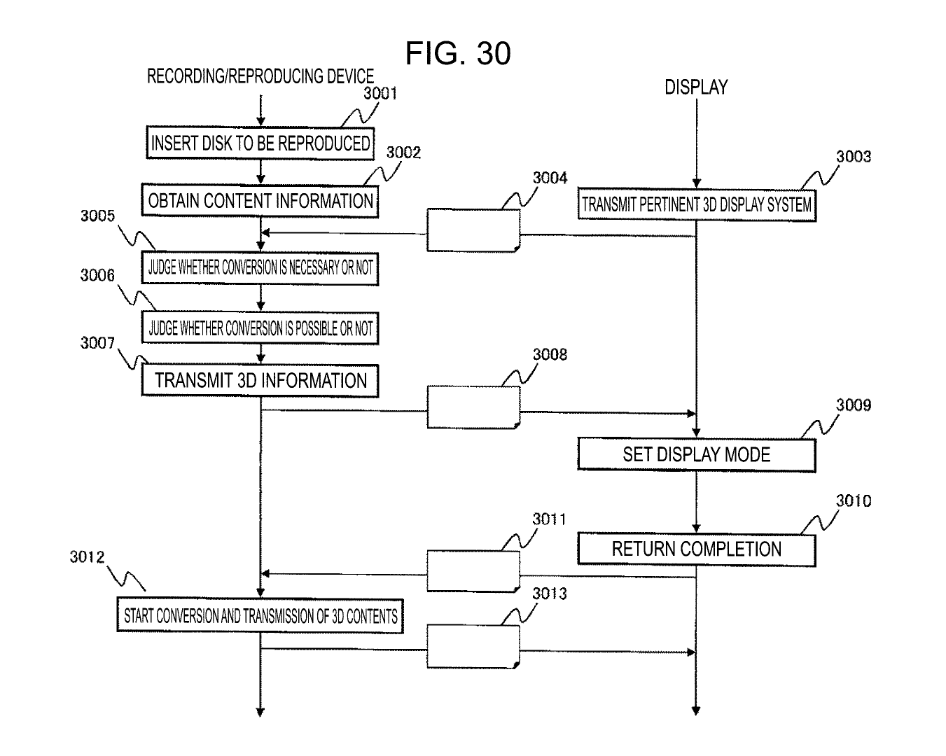

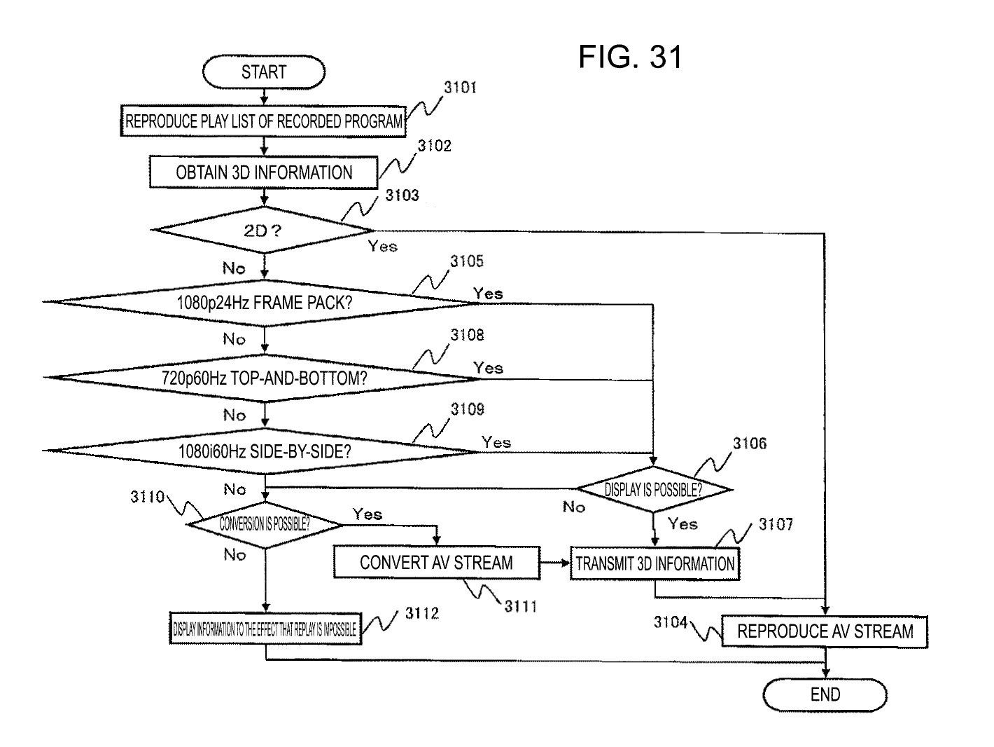

FIG. 30 is a timing chart showing an example of processing of the recording/reproducing device and the display.

When a disk to be reproduced is inserted into the recording/reproducing device (step 3001), information concerning contents is read out from the disk (step 3002). The information concerning the contents also contains information concerning 3D such as the 3D flag 321 and the 3D type 322. The obtained 3D information 3004 is transmitted to the display through the digital I/F connected to the display (step 3003). The display receives the 3D information transmitted from the recording/reproducing device and analyzes the contents thereof (step 3005). The display collates the analyzed result with the 3D system relevant to the display and judges whether the information can be displayed without conversion or conversion is required, so that an optimum display mode is set (step 3006). After the setting is completed, information 3008 to the effect that the setting is completed normally is returned to the recording/reproducing device (step 3007). When the information is the contents which cannot be displayed as a result of judgment in step 3006, information of error which means that displaying is impossible is returned in step 3007. When the recording/reproducing device receives the information 3008 to the effect that the setting is completed normally, the recording/reproducing device starts to transmit the 3D contents 3009. When error information is received, the recording/reproducing device notifies the user to the effect that displaying is impossible without transmitting the 3D contents. At this time, the notification may be displayed in the display by OSD.

Another example of the processing of the recording/reproducing device and the display in the embodiment is described.

FIG. 30 is a timing chart showing an example of processing of the recording/reproducing device and the display.

When a disk to be reproduced is inserted into the recording/reproducing device (step 3001), information concerning contents is read out from the disk (step 3002). The information concerning the contents also contains information concerning 3D such as the 3D flag 321 and the 3D type 322. On the other hand, the display transmits the information 3004 of the 3D system relevant to the display through the digital I/F connected to the display to the recording/reproducing device (step 3003). The recording/reproducing device collates the information 3004 of the 3D system transmitted from the display with 3D information of the contents obtained in step 3002 to judge whether the information can be displayed without conversion or conversion is required (step 3005). When conversion is required, the recording/reproducing device judges whether conversion is possible or not (step 3006). When conversion is possible, the information 3008 of 2D/3D system of the contents to be transmitted is notified to the display (step 3007). The display receives the information 3008 of 2D/3D system transmitted from the recording/reproducing device and sets a display mode (step 3009). When conversion is impossible, the recording/reproducing device notifies the user to the effect that displaying is impossible. At this time, the notification may be displayed in the display by OSD.

In this case, the 3D contents are not transmitted to the display. After the display mode is set (step 3009), the display returns information 3011 to the effect that the setting is completed normally to the recording/reproducing device (step 3010). The recording/reproducing device converts the 3D contents into contents 3013 and transmits the converted contents 3013 to the display (step 3012).

Referring to FIG. 31, the processing flow of reproducing of 3D type 322 is described.

When the recorded contents are reproduced by the recording/reproducing device, the play list is reproduced (step 3101). Information indicating the 3D system is obtained from the 3D type information 322 contained in the play list (step 3102). When the information is 000 (step 3103), it is judged that the contents are 2D contents and AV stream is reproduced (step 3104).

When the information is not 000 (step 3103), it is judged whether the information is 100 or not (step 3105). When the information is 100 (step 3105), it is judged that the information is 1080p24 Hz frame pack and it is confirmed whether the 1080p24 Hz frame pack is contained in the 3D system relevant to the display or not (step 3106). When the 1080p24 Hz frame pack is contained, it is judged that displaying is possible (step 3106), so that 3D information is transmitted (step 3107) and AV stream is reproduced (step 3104). When the 1080p24 Hz frame pack is not contained, it is judged that displaying is impossible (step 3106) and it is confirmed whether the recording/reproducing device can cope with conversion function of the contents of the 1080p24 Hz frame pack or not (step 3110). When the recording/reproducing device can cope with the conversion function (step 3110), the recording/reproducing device performs conversion of the AV stream (step 3111), transmission of the 3D information (step 3107) and reproducing of the AV stream (step 3104).

When the recording/reproducing device cannot cope with the conversion function (step 3110), information to the effect that reproduce is impossible is displayed to be notified to the user (step 3112).

When the information is not 100 (step 3105), it is judged whether the information is 010 or not (step 3108). When the information is 010 (step 3108), it is judged that the information is 720p60 Hz top-and-bottom and it is confirmed whether the 720p60 Hz top-and-bottom is contained in the 3D system relevant to the display or not (step 3106). When the 720p60 Hz top-and-bottom is contained, it is judged that displaying is possible (step 3106), so that 3D information is transmitted (step 3107) and AV stream is reproduced (step 3104). When the 720p60 Hz top-and-bottom is not contained, it is judged that displaying is impossible (step 3106) and it is confirmed whether the recording/reproducing device can cope with conversion function of the contents of the 720p60 Hz top-and-bottom or not (step 3110). When the recording/reproducing device can cope with the conversion function (step 3110), the recording/reproducing device performs conversion of the AV stream (step 3111), transmission of the 3D information (step 3107) and reproducing of the AV stream (step 3104).

When the recording/reproducing device cannot cope with the conversion function (step 3110), information to the effect that reproduce is impossible is displayed to be notified to the user (step 3112).

When the information is not 010 (step 3108), it is judged whether the information is 110 or not (step 3109). When the information is 110 (step 3109), it is judged that the information is 1080i60 Hz side-by-side and it is confirmed whether the 1080i60 Hz side-by-side is contained in the 3D system relevant to the display or not (step 3106). When the 1080i60 Hz side-by-side is contained, it is judged that displaying is possible (step 3106), so that 3D information is transmitted (step 3107) and AV stream is reproduced (step 3104). When the 1080i60 Hz side-by-side is not contained, it is judged that displaying is impossible (step 3106) and it is confirmed whether the recording/reproducing device can cope with conversion function of the contents of the 1080i60 Hz side-by-side or not (step 3110). When the recording/reproducing device can cope with the conversion function (step 3110), the recording/reproducing device performs conversion of the AV stream (step 3111), transmission of the 3D information (step 3107) and reproduce of the AV stream (step 3104).

When the recording/reproducing device cannot cope with the conversion function (step 3110), information to the effect that reproduce is impossible is displayed to be notified to the user (step 3112).

As described above, the 3D type of the contents can be reproduce correctly and when reproduce is impossible, information to the effect that reproduce is impossible can be notified to the user.

Referring to FIG. 27, processing of reading out desired data from the AV stream file to display the data in the display is described in detail.

The AV stream file read out from the main recording medium 2726 is supplied to the multiplex separation part 2729 through the recording/reproducing part 2727 to be separated into elementary streams. The image stream is transferred to the image decoding conversion part 2730 and the audio stream is transferred to the audio decoding conversion part 2731.

The image stream is decoded by the image decoding conversion part 2730 and is outputted through the image conversion processing part 2732 from the image signal output part 2741.

The audio stream is decoded by the audio decoding conversion part 2731 and is outputted from the audio output 2742.

Referring to FIG. 28, the recording/reproducing part 2727 is described in detail.

The image audio stream data of the AV stream file recorded in the main recording medium 2826 is read out by the length designated by the designation sector in response to a read request command from the storage I/F 2865 and is stored in the buffer 2864 by a fixed amount or more.

The stream data stored in the buffer 2864 is read out in TS packet unit in response to a request from the depacketizer 2866 and the packet thereof is dissolved or depacketed by the depacketizer 2866. The arrival time stamp in the header thereof is analyzed. The arrival time stamp is compared with the clock information supplied from the counter 2872 and the packet is transferred to the decoding part 2867 at correct intervals. The decoding part 2867 decodes encryption of the packet to be supplied to the multiplex separation part 2829.

On the other hand, even in the path passing through the buffer 2864 to the depacketizer 2868 and the decoding part 2869, the same processing is performed. Thus, the stream processing of two systems can be performed at the same time to thereby realize the function that a sub picture is superimposed on a main picture such as, for example, PictureInPicture function and PopUpMenu function. Further, simultaneous processing of the AV stream file read out from the main recording medium 2826 and the AV stream file read out from the sub-recording medium 2850 can be realized similarly.

The present invention is not limited to the above embodiments and various modifications are contained therein. For example, the embodiments are described in detail for easy understanding of the present invention and are not necessarily limited to provision of all the structure described. Moreover, part of the structure of an embodiment may be replaced by the structure of another embodiment and further the structure of an embodiment may be added to the structure of another embodiment. Further, part of the structure of the embodiments may be subjected to addition, deletion and replacement of other structure.

Further, part or all of the above structure, function, processing parts, processing means and the like may be realized in hardware by designing integrated circuits, for example. Moreover, the above structure, function and the like may be realized by software by interpretation and execution of programs for realizing respective functions by means of a processor. Information of programs, tables, files and the like for realizing the functions may be stored in a memory, a recording device such as hard disk and SSD (Solid State Drive) or a recording medium such as IC card, SD Card™ and DVD.

In addition, control lines and information lines considered to be required for description are shown and all of control lines and information lines required for a product are not necessarily shown. Actually, almost all structures may be considered to be connected mutually.

Further, the case where information is reproduced from the main recording medium 2726 has been described, although even when information is reproduced from the sub-recording medium 2750, the same effects can be attained.

The method of controlling whether the recording medium for recording/reproducing is the main recording medium 2726 or the sub-recording medium 2750 may be realized by describing a recording medium to be used in a management file recorded in the main recording medium 2726 in file unit. Further, link information for recording the file recorded in the sub-recording medium 2750 into the main recording medium 2726 in a pseudo manner may be recorded in the management file of the main recording medium 2726, so that reproducing from both of the recording mediums can be realized without being conscious of reproducing from the sub-recording medium 2750.

### REFERENCE SIGNS LIST

301 . . . length
302 . . . character code
303 . . . reproduce protection flag
304 . . . record protection flag
305 . . . reproduce completion flag
306 . . . editing completion flag
307 . . . time zone
308 . . . recording date and time
309 . . . play list length
310 . . . maker ID
311 . . . model code
312 . . . channel number
313 . . . channel name length
314 . . . channel name
315 . . . play list name length
316 . . . play list name
317 . . . play list detail length
318 . . . play list detail
321 . . . 3D flag
322 . . . 3D type

1. A recording method of recording information in a recording medium, comprising:
a step of recording AV streams; and
a step of recording a play list in which reproduce order of the AV streams is prescribed; and
wherein
the play list includes user interface application information and
the interface application information includes 3D type information representing a 3D system of 3D contents in the play list,
the 3D type information being information outputted in order to judge whether the 3D contents can be displayed in an external display or not.

2. A recording device which records information in a recording medium, comprising:
a recording part to record AV streams and a play list in which reproduce order of the AV streams is prescribed in the recording medium; and
a control part to control the recording part; and
wherein
the control part controls the recording part to record information in the recording medium so that the play list includes user interface application information, the interface application information includes 3D type information representing a 3D system of 3D contents in the play list and the 3D type information is information outputted in order to judge whether the 3D contents can be displayed in an external display or not.

3. A reproducing method of reproducing information recorded in a recording medium, wherein
AV streams and a play list in which reproduce order of the AV streams is prescribed are recorded in the recording medium and
the play list includes user interface application information,
the interface application information including 3D type information representing a 3D system of 3D contents in the play list,
the 3D type information being information outputted in order to judge whether the 3D contents can be displayed in an external display or not, and
the reproducing method comprising:
a step of reproducing the AV streams; and
a step of reproducing the play list,
the 3D type information being outputted to make reproduce.

4. A reproducing device which reproduce information recorded in a recording medium, comprising:
a reproduce part to reproduce information from the recording medium; and
a control part to control the reproducing part; and
wherein
AV streams and a play list in which reproduce order of the AV streams is prescribed are recorded in the recording medium, and
the play list includes user interface application information,
the interface application information including 3D type information representing a 3D system of 3D contents in the play list,
the 3D type information being information outputted in order to judge whether the 3D contents can be displayed in an external display or not,
the 3D type information being outputted to make reproduce.

5. A recording medium in which information is recorded, comprising:
AV streams; and
a play list in which reproduce order of the AV streams is prescribed; and
wherein
the play list includes user interface application information and
the interface application information includes 3D type information representing a 3D system of 3D contents,
the 3D type information being information outputted in order to judge whether the 3D contents can be displayed in an external display or not.
